(19) United States
(12) Patent Application Publication
(10) Pub. No.: US 2018/0000286 A1
(43) Pub. Date: Jan. 4, 2018

(54) LOW OIL USAGE TURKEY FRYER

(71) Applicants: Alan BACKUS, Los Angeles, CA (US); Marici IULIUS, Las Vegas, NV (US)

(72) Inventors: Alan BACKUS, Los Angeles, CA (US); Marici IULIUS, Las Vegas, NV (US)

(21) Appl. No.: 15/636,994

(22) Filed: Jun. 29, 2017

Related U.S. Application Data
(63) Continuation-in-part of application No. 15/614,746, filed on Jun. 6, 2017.
Application No. 15/614,746 is a continuation of application No. 15/297,788, filed on Oct. 19, 2016.
Application No. 15/297,788 is a continuation-in-part of application No. 15/142,072, filed on Apr. 29, 2016.

(51) Int. Cl. A47J 37/12

(52) U.S. Cl. CPC A47J 37/129; A47J 37/1285; A47J 37/1261; A47J 37/128

(57) ABSTRACT

Food supports comprising vertical walled sleeves of both fixed and variable circumferences, and adaptable to be used standalone or to be used while disposed within a fry basket. A filter filters which filter cooking liquid while it remains within a cooking vessel. A supports is configured to contact and compress large food items. A heating apparatus is configured to allow foods to more efficiently adapt to restricted height circumstances. A cooking liquid overflow control includes a spillway and a storage reservoir. An emissions filter is configured to segregate filtered material through condensation as well as debris collection. A cooking device is configured for filtration and storage of both liquid and gaseous emissions. A user controlled power shutoff is configured to facilitate user access for quick disconnection via a magnetic plug. A full containment food support is configured to provide controlled entry and exit of fluids. A food support basket, is configured to be adaptable to immersing foods in liquids and/or suspending foods above liquids.

### CROSS-REFERENCE TO RELATED APPLICATIONS

This application claims the benefit of co-pending U.S. patent application Ser. No. 15/258,453 filed Sep. 7, 2016; Ser. No. 15/297,788 filed Oct. 19, 2016 and Ser. No. 15/614,746 filed Jun. 6, 2017, all of which are incorporated herein by reference.

### TECHNICAL FIELD

The present application is directed to devices which deep fry foods, including larger unitary food items, further including whole turkeys.

### BACKGROUND

Devices to deep fry whole turkeys have been around in the United States, at least since the mid-1930s. Early devices consisted simply of cleaned out 55 gallon metal oil drums, partially filled with cooking oil, and placed with a turkey in them, on a rack, over an open fire.

These are the direct ancestors of today's bottled gas-fired fired turkey fryer products, which typically consist of unstable metal framework bases, holding open flame gas-fired burners, under metal vessels, containing 2½ to over 6 gallons of hot frying liquid.

Also around are variants of these current gas fired devices, which are electrically energized and used indoors. These have come in many shapes and sizes, but generally have a cylindrical or rectangular open-topped cooking vessel, holding 2½ or more gallons of frying oil, with an immersive electrically resistive rod heating element submerged in the frying oil.

In 2016, the American National Standards Institute (ANSI) developed new safety standards (referred to as “UL 1083 Large Food Items”) regarding deep fryers which cook unitary food items greater than 5 pounds.

Among many other requirements these new standards mandated, are the use of no more than 5 L (5.28 quarts) of cooking oil, and a maximum immersed load (food weight plus lifted food support structure weight) of 15 pounds.

The first device to meet these new standards used a two-step deep frying process, where first a turkey was immersed breast down into hot cooking oil long enough for it to cook, and the first half of the turkey was fried; and then the turkey was flipped over and cooked a second time with its feet down.

Surprisingly, even with this somewhat complex two-stage process, the final result could be excellent.

Even so, at least three things might be improved upon.

The first has to do with deep frying itself. Typically, turkeys are deep fried in hot oil above 375° F. When raw turkeys, which are generally quite moist, are first introduced into hot oil, a typically violent boiling reaction occurs, usually causing hot oil to unsafely splatter. It would be desirable to control this boiling reaction in such a manner as to improve user safety.

A second possible improvement also is inherent in deep frying. Deep frying, using high oil cooking temperatures and efficient oil heat transfer, allows relatively short cooking times, when compared with traditional oven cooking. But like oven cooking, high temperatures also dry out the turkey meat and make the meat tougher. Brining, marinating, injecting the turkey with oil, butter and other ingredients, covering the turkey with aluminum foil, and other techniques have been used to combat this, but have met with only limited success. It would be desirable, during frying, to retain more of the turkey's natural moisture and flavor within the turkey.

And third, it might be advantageous to simplify the frying process, which has now become more complex due to the use of the aforementioned two-stage deep frying process and the manner in which it is currently performed.

### SUMMARY

Several embodiments of the subject application are described herein.

FIGS. 1 through 20 and 64 through 70 show examples of devices which might be used in conjunction with two-stage turkey fryers, as described above, and which are similar in function to fryers shown in U.S. Pat. No. 8,309,151, FIGS. 147 through 185; as well as might be used in conjunction with other frying, as well as with other non-frying, food cooking devices.

FIGS. 21 through 62 show standalone devices capable at least of cooking unitary food items.

FIG. 63 shows a new use for food items prepared in deep fat fryers.

### BRIEF DESCRIPTION OF THE DRAWINGS

Various embodiments will become better understood with regard to the following description, appended claims and accompanying drawings wherein:

FIG. 1 is a perspective of fryer 514.

FIG. 2 is an exploded perspective of the device shown in FIG. 1.

FIG. 3 is an exploded perspective of embodiment 500.

FIG. 4 is a perspective of circumference adjustable sleeve 502, in its open uncoupled disposition.

FIG. 5 is a perspective of circumference adjustable sleeve 502, in its most expanded use position.

FIG. 6 is a perspective of circumference adjustable sleeve 502, in its most constricted use position.

FIG. 7 is a detail of FIG. 4, as indicated in FIG. 4.

FIG. 8 is a detail of FIG. 5, as indicated in FIG. 5.

FIG. 9 shows circumference adjustable sleeve 502 in use in the disposition shown in FIG. 5 with a breast down foul (large food items 506).

FIG. 10 shows circumference adjustable sleeve 502 in use in the disposition shown in FIG. 5, with a breast up foul (large food items 506).

FIG. 11 shows circumference adjustable sleeve 502 in use in the disposition shown in FIG. 6, with a breast down small foul (other small items 508).

FIG. 12 shows circumference adjustable sleeve 502 in use in the disposition shown in FIG. 6, with a breast up small foul (other smaller items 508).

FIG. 13 is a perspective of fryer 514.

FIG. 14 is an exploded perspective of fryer 514.

FIG. 15 is an exploded perspective of fryer 514, taken from above the ground plane.

FIG. 16 is an exploded perspective of fryer 514, taken from below the ground plane.

FIG. 17 is a perspective view of embodiment 516.

FIG. 18 is a perspective view of embodiment 517 holding large food item 506.

FIG. 19 is an exploded perspective, viewed from below the ground plane, showing embodiment 515.

FIG. 20 is an exploded perspective, viewed from below the ground plane, showing embodiment 520.

FIG. 21 is a frontal perspective of embodiment 522.

FIG. 22 is a perspective of embodiment 522, taken from a viewpoint behind embodiment 522.

FIG. 23 is a perspective of food item 524, with maximum girth 620 being measured with pliable rule 526.

FIG. 24 is a cross-section through embodiment 522 as indicated in FIG. 21, with food item 524 having its girth measured, with pliable rule 528.

FIG. 25 is an exploded perspective of embodiment 522.

FIG. 26 is a frontal perspective of embodiment 530.

FIG. 27 is a perspective of embodiment 530, viewed from behind embodiment 530, and from below the ground plane.

FIG. 28 is a frontal exploded perspective of embodiment 530.

FIG. 29 is an exploded perspective of embodiment 530, viewed from behind embodiment 530, and from below the ground plane.

FIG. 30 is a frontal perspective of embodiment 532.

FIG. 31 is a frontal perspective of embodiment 532, with food support 538 in its food draining position.

FIG. 32 is a frontal perspective of embodiment 532, with food support 538 being lifted out of cooking vessel 536.

FIG. 33 is an exploded frontal perspective of embodiment 532.

FIG. 34 is a detail of FIG. 33, as indicated in FIG. 33.

FIG. 35 is a detail of FIG. 33, as indicated in FIG. 33.

FIG. 36 is an exploded perspective of embodiment 532, viewed from behind embodiment 532, and from below the ground plane.

FIG. 37 is a perspective section of embodiment 532, as indicated in FIG. 39.

FIG. 38 is a perspective section of embodiment 532, as indicated in FIG. 39.

FIG. 39 is a plan view of embodiment 532.

FIG. 40 is a detail of FIG. 37, as indicated in FIG. 37.

FIG. 41 is a detail of FIG. 38, as indicated in FIG. 38.

FIG. 42 is a perspective of food support 538, with handle 682 removed from handle mounting bracket 542.

FIG. 43 is a perspective of food support 538, with handle 682 couple to handle mounting bracket 542.

FIG. 44 is a detail of FIG. 42, as indicated in FIG. 42.

FIG. 45 is a detail of FIG. 43, as indicated in FIG. 43.

FIG. 46 is a frontal perspective of food support 538.

FIG. 47 is a perspective section of food support 538, taken from the section plane indicated in FIG. 46.

FIG. 48 is a perspective of embodiment 558.

FIG. 49 is a frontal view of embodiment 558.

FIG. 50 is a frontal section taken through FIG. 48, as indicated in FIG. 48.

FIG. 51 is a perspective view from below the ground plane of cooking vessel 544, which mounts heating coil 546.

FIG. 51A is a section taken through FIG. 51, as indicated in FIG. 51.

FIG. 51B is a section taken through FIG. 51, as indicated in FIG. 51.

FIG. 52 is a perspective viewed from below the ground plane of cooking vessel 548, which mounts heating coil 726.

FIG. 52A is a section taken through FIG. 52, as indicated in FIG. 52.

FIG. 53 is a perspective viewed from below the ground plane of cooking vessel 552, which mounts heating coil 550.

FIG. 53A is a section taken through FIG. 53, as indicated in FIG. 53.

FIG. 54 is a perspective viewed from below the ground plane of cooking vessel 554, which mounts heating coil 556.

FIG. 54A is a section taken through FIG. 54, as indicated in FIG. 54.

FIG. 54B is a section taken through FIG. 54, as indicated in FIG. 54.

FIG. 55 is an exploded perspective of embodiment 558.

FIG. 56 is an exploded perspective of embodiment 558, viewed from behind and viewed from below the ground plane.

FIG. 57 is a perspective of embodiment 560.

FIG. 58 is a perspective section taken through FIG. 57, as indicated in FIG. 57.

FIG. 59 is an exploded perspective of embodiment 558.

FIG. 60 is a perspective of food support 562, viewed from below the ground plane.

FIG. 61 is a perspective section taken through FIG. 57, as indicated in FIG. 57.

FIG. 62 is a perspective of embodiment 560.

FIG. 63 is a graphic representation of a method to use deep fat fried foods to lose weight.

FIG. 64 is an exploded perspective of embodiment 770.

FIG. 65 is a detail of FIG. 64 as indicated in FIG. 64.

FIG. 66 is an exploded perspective of embodiment 770, taken from behind embodiment 770, and from below the ground plane.

FIG. 67 is an exploded perspective of embodiment 784, which has been taken from behind embodiment 784, and from below the ground plane.

FIG. 68 is a partially exploded perspective of embodiment 784, which has been taken from behind embodiment 784, and from below the ground plane.

FIG. 69 is a partially exploded perspective of embodiment 798, which has been taken from behind embodiment 798, and from below the ground plane.

FIG. 70 is a partially exploded perspective of embodiment 798 as shown in FIG. 69 after further preparation for a cooking operation.

### DETAILED DESCRIPTION

FIGS. 1 Through 20, Embodiments Suitably Used in Conjunction with an Existing Fryer:

FIGS. 1 through 20, show embodiments being used in deep fryer 514 which is suitably similar in construction to that fryer found in U.S. Pat. No. 8,309,151, FIGS. 147 through 185. Deep fryer 514 is comprised of: outer enclosure 564, which mounts within it cooking vessel 566, which in turn, is configured to telescopically mount annular side wall extension sleeve 568.

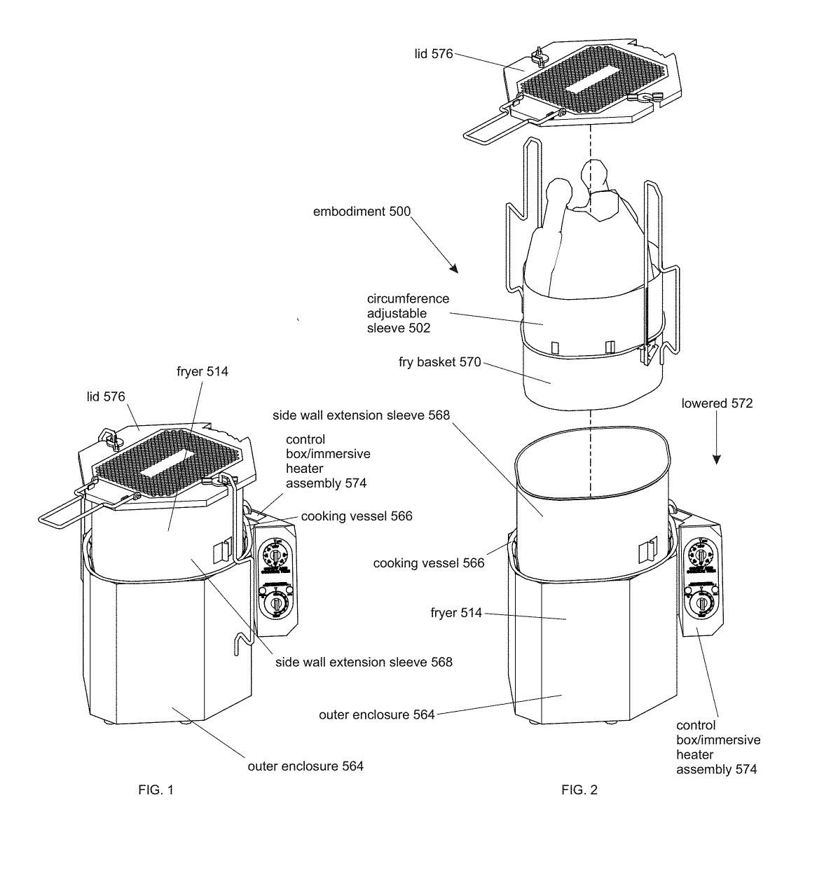

As shown in FIG. 2, fry basket 570 is configured to be lowered 572 through extension sleeve 568 into cooking vessel 566; or alternatively, as shown in FIGS. 14, 15, and 16, if extension sleeve 568 is not in place, fry basket 570 is configured to be lowered directly into cooking vessel 566.

Cooking vessel 566 is configured to both hold food to be cooked, as well as, simultaneously, cooking liquid which is thermostatically heated to cooking temperatures by house current powered control box/immersive heater assembly 574.

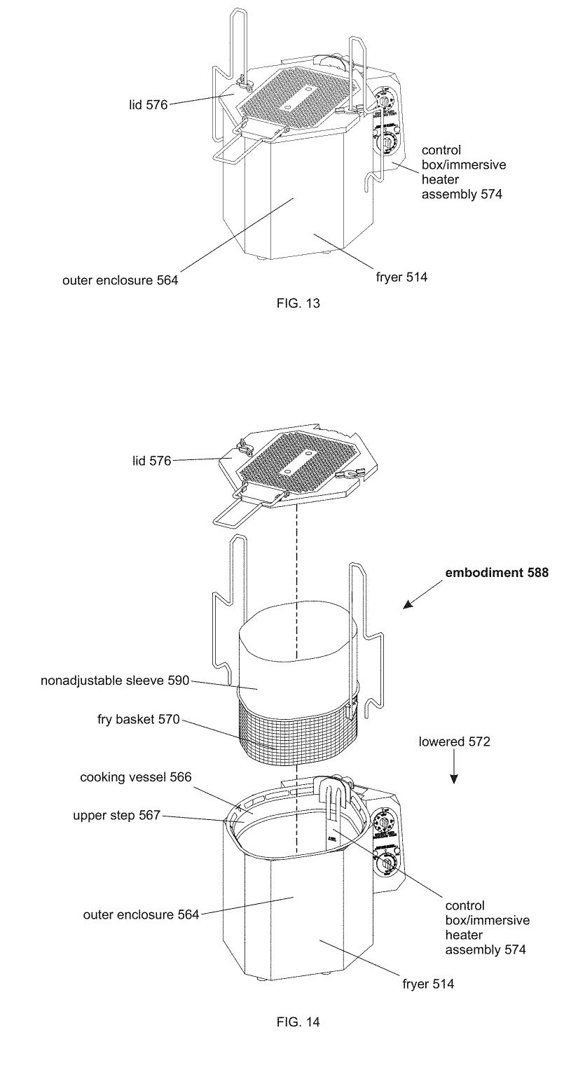

Lid 576 Is configured to cap side wall extension sleeve 568, as shown in FIG. 1; or alternatively, to cap cooking vessel 566 directly, as shown in FIGS. 13 and 14.

FIG. 2 shows fry basket 570 holding circumference adjustable sleeve 502 being lowered 572 through side wall extension sleeve 568 and into cooking vessel 566.

Fry basket 570 may be of any advantageous construction, including, as non-limiting and non-exhaustive examples: course or find screening (quarter-inch or more mesh, to 0.01 inch or less mesh), perforated sheet of course or fine design, or non-perforated sheet or any other suitable form; and may be constructed from metal, plastic, composite, or any other suitable material.

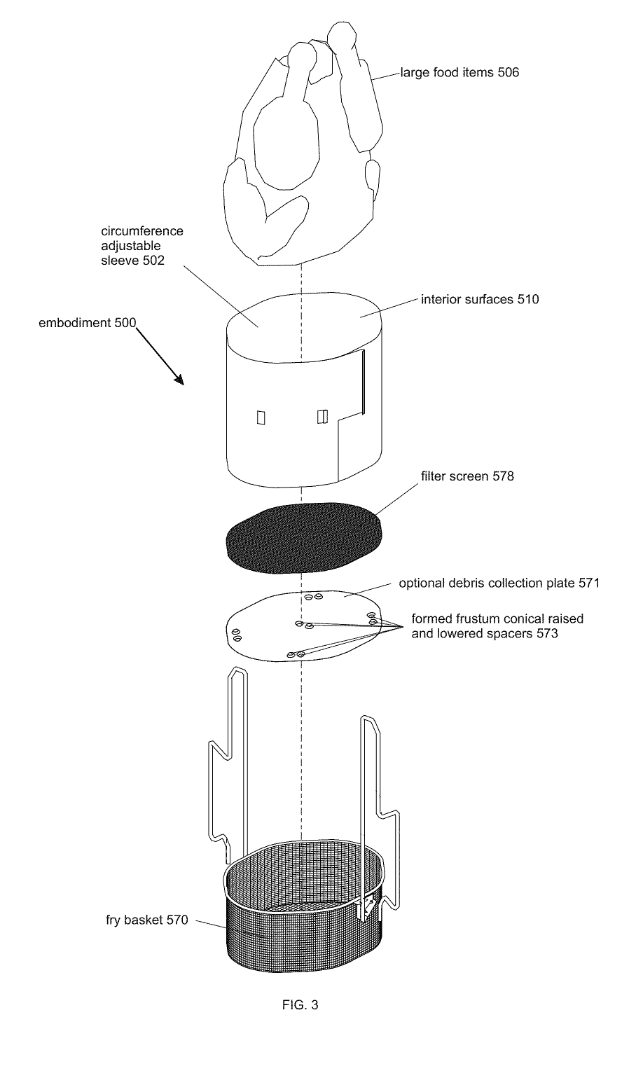

FIG. 3 shows an exploded view with filter screen 578 being placed on the floor of fry basket 570 underneath circumference adjustable sleeve 502 which circumnavigates large food 508. Filter screen 578 is configured to filter debris from cooking liquid passing through it.

As a non-exhaustive and non-limiting example, filter screen 578 may be constructed of any suitable material, including, but not limited to: window screening or finer screening, filter media, such as paper drip coffee filters, paper towels, perforated metal sheet material, such as, but not limited to, metal drip coffee filters or perforated speaker grill, molded plastic screening, course or fine expanded metal screening, or any other suitable filtering material. Filter screen 578 may advantageously exhibit a nonstick surface at least to ease cleaning and/or aid in foods not sticking.

FIG. 3 also shows optional debris collection plate 571, which is spaced away from filter screen 578 by at least 1/10 of an inch by formed frustum conical, also known as frustoconical, raised and lowered spacers 573. Optional debris collection plate 571 is generally planner with formed frustum conical raised and lowered spacers 573 protruding upward and downward away from generally planner plate 571. Debris settling through, but not captured by, filter screen 578 may be collected on the upper facing surfaces of optional debris collection plate 571. At any time, including after any cooking has been completed, optional debris collection plate 571, along with filter screen 578 may be conveniently cleaned in a dishwasher, sink, or other suitable way, to simplify and speed cleanup.

Optional debris collection plate 571 may be advantageously coated on either or both of its facial surfaces with a nonstick coating to further ease cleanup.

Circumference adjustable sleeve 502 may be constructed of any suitable material, such as, as non-limiting and non-exhaustive examples, metal or plastic sheet; and may have interior surface 510 of circumference adjustable sleeve 502 advantageously exhibiting a nonstick surface, to at least aid in foods not sticking, and/or to help in cleanup.

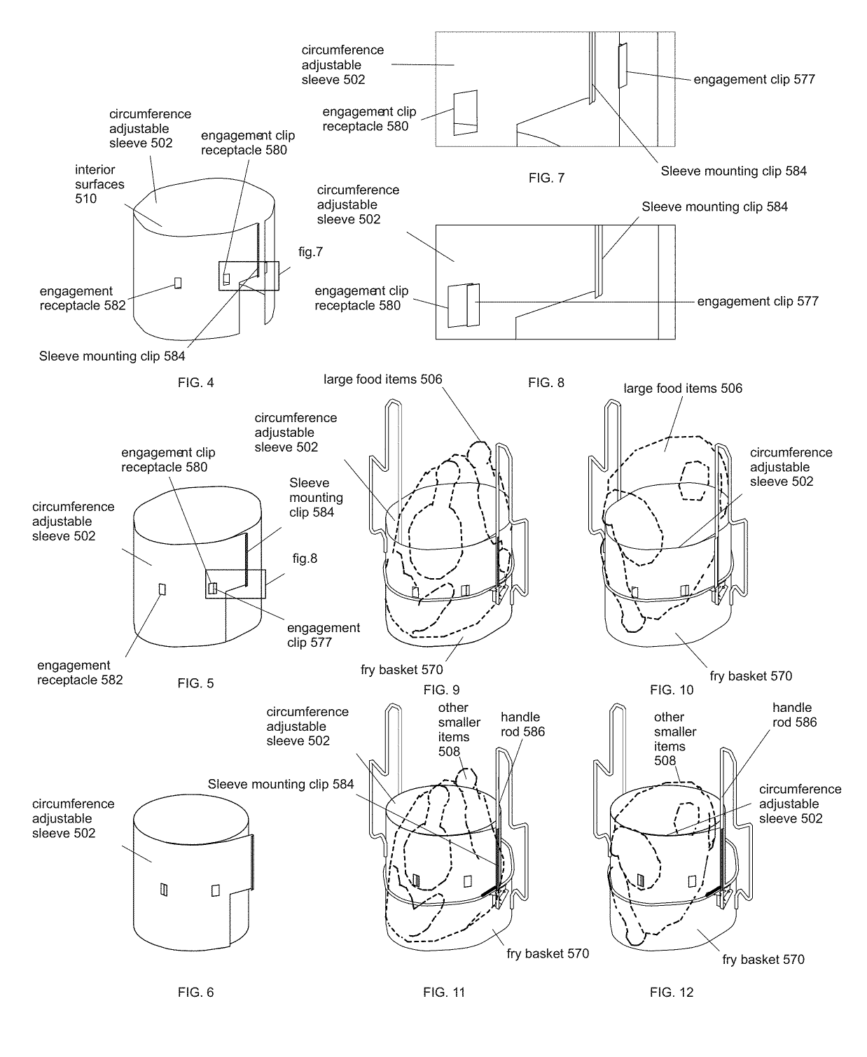

FIGS. 4 through 12 show various operating modes for circumference adjustable sleeve 502. In FIG. 4, circumference adjustable sleeve 502 is open. This can happen when engagement clip 577 is uncoupled from both engagement clip receptacle 580 and from engagement receptacle 582.

In FIGS. 5, 9, and 10; engagement clip 577 is coupled to engagement clip receptacle 580 to constrict circumference adjustable sleeve 502 to its most open operating condition, where it can hold its maximum food load, such as large food item 506.

In FIGS. 6, 11, and 12; engagement clip 577 is coupled to engagement clip receptacle 582 to constrict circumference adjustable sleeve 502 to support smaller food items, such as other smaller items 508.

If more precise circumference adjustment is desirable, one or more intermediate engagement clip receptacles may be disposed between engagement clip receptacle 580 and engagement clip receptacle 582.

Sleeve mounting clip 584 snaps onto handle rod 586 to help dispose circumference adjustable sleeve 502 vertically within fry basket 570. Sleeve mounting clip 584 is optional. Circumference adjustable sleeve 502 may be operated with the absence of sleeve mounting clip 584.

In use, as a non-limiting and non-exhaustive example, using engagement clip 577 and engagement clip receptacles 580 and 582; the user adjusts circumference adjustable sleeve 502 to a circumference matching the size of the food to be cooked.

Next optionally, filter screen 578 may be placed into fry basket 507 to filter debris from cooking liquid. This filtering may be done by passing cooking liquid through filter screen 578, at least when fry basket 570 is either lowered into, or withdrawn from, cooking liquid. Filter screen 578 may advantageously be coated with a nonstick surface, and may be dishwasher safe, at least for easy cleaning, and/or to help prevent food sticking.

Filter screen 578, operates most efficiently when there is at least one 1/10 of an inch of space between its filtering surface and other proximate surfaces.

Next, the user places circumference adjustable sleeve 502, either directly on top of the floor of fry basket 507, or on top of filter screen 578, if it is in place. Optionally, as explained above, the user then clips sleeve mounting clip 584 onto handle rod 586.

Next, a food item, such as large food item 506, or other smaller items 508, or other singular or plural suitable pieces of food is/are placed into circumference adjustable sleeve 502, and the entire assembly comprising fry basket 570, circumference adjustable sleeve 502, and food item, either 506 or 508, or other suitable food is/are lowered into cooking liquid.

After a predetermined amount of cooking time, the food is lifted out of the cooking liquid for further processing, or to be served.

The above steps may be repeated as often as useful.

### FIGS. 13 and 14, Embodiment 588:

Embodiment 588 comprises nonadjustable sleeve 590, which is constructed like, and replaces, circumference adjustable sleeve 502 in embodiment 500. The function and use of embodiment 588 are generally the same as those for embodiment 500. In FIGS. 13 and 14, side wall extension sleeve 568 is shown in its removed disposition.

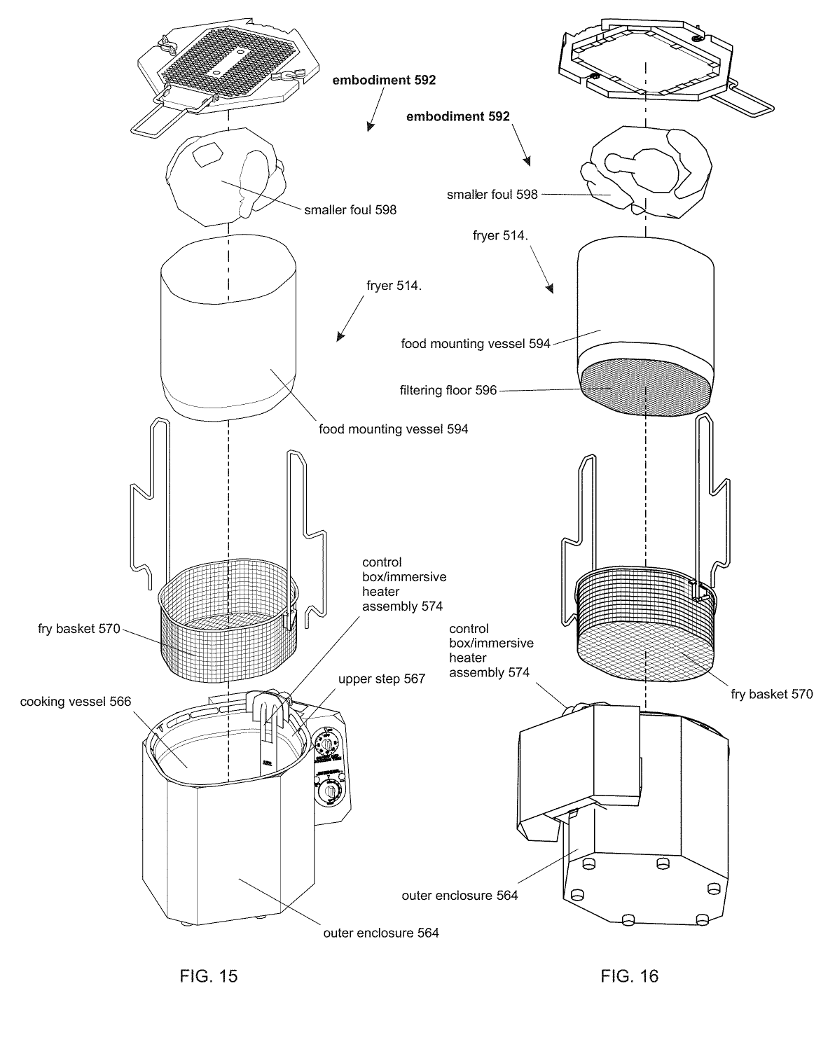

### FIGS. 15 and 16, Embodiment 592:

Embodiment 592 comprises food mounting vessel 594 which is substituted for, and is constructed similarly to, circumference adjustable sleeve 502 and filter screen 578 in embodiment 500. Food mounting vessel 594 has filtering floor 596, which may be constructed and used similarly to filter screen 578.

FIGS. 15 and 16 also show the use of embodiment 592 to mount a smaller foul 598 horizontally. Embodiment 592 and all cooking embodiments herein, may mount food items in any disposition, including at least: vertically, horizontally, diagonally, etc. and may cook such items totally in a single step, or in multiple partial steps.

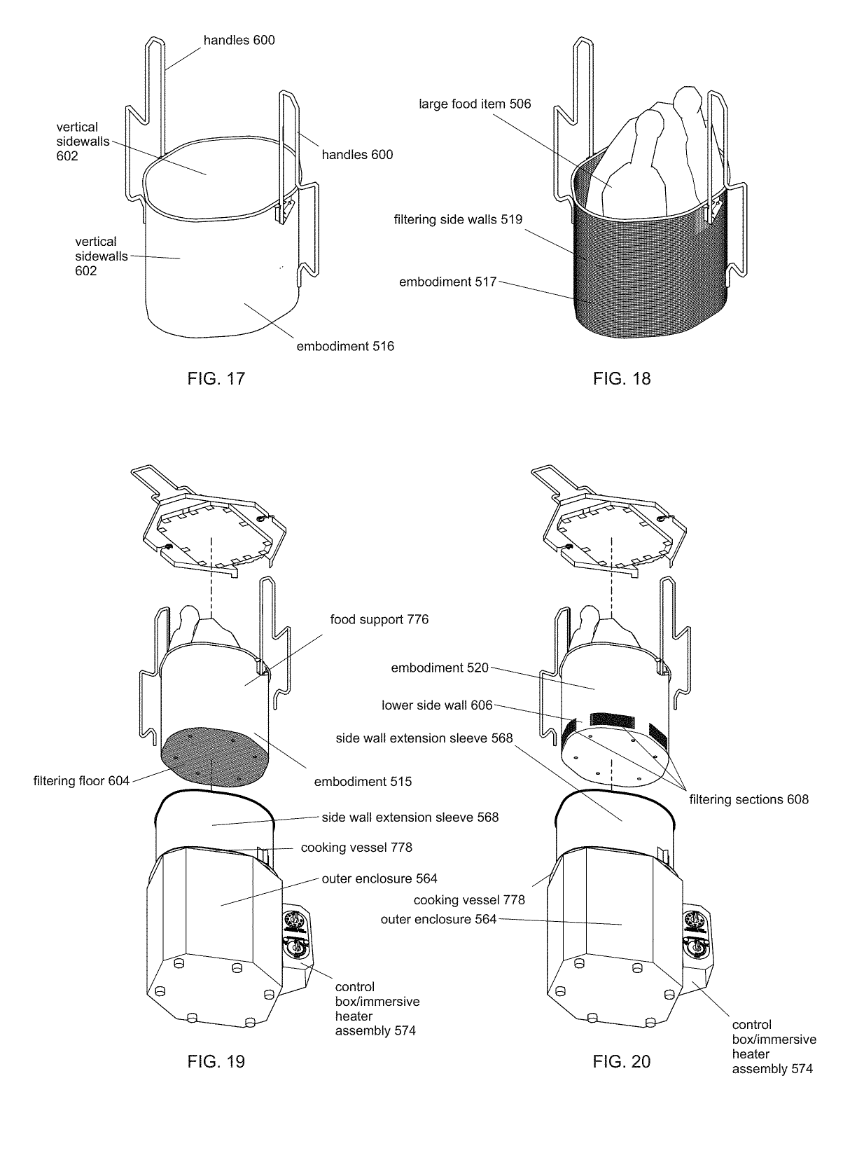

### FIGS. 17 and 19, Embodiment 516:

Embodiment 516, is constructed similar to embodiment 500, except fry basket 570 has been eliminated, handles 600 are directly attached to vertical side walls 602, and filter screen 578 has been replaced by filtering floor 604, which may be used and constructed similarly to filter screen 578.

### FIG. 18, Embodiment 517:

Embodiment 517 is constructed similarly to embodiment 516, except vertical side walls 602 and floor (not shown) are constructed like, and may function similarly to, filter screen 578.

Various embodiments are not shown which resemble embodiment 517, except they replace with blocking sheet, any or some portions of the filtering material used in the filtering side walls 519 and filtering floor (not shown) of embodiment 517.

### FIG. 20, Embodiment 520:

FIG. 20 shows one of the embodiments just mentioned above which has filtering sections 608 only in lower side wall 606.

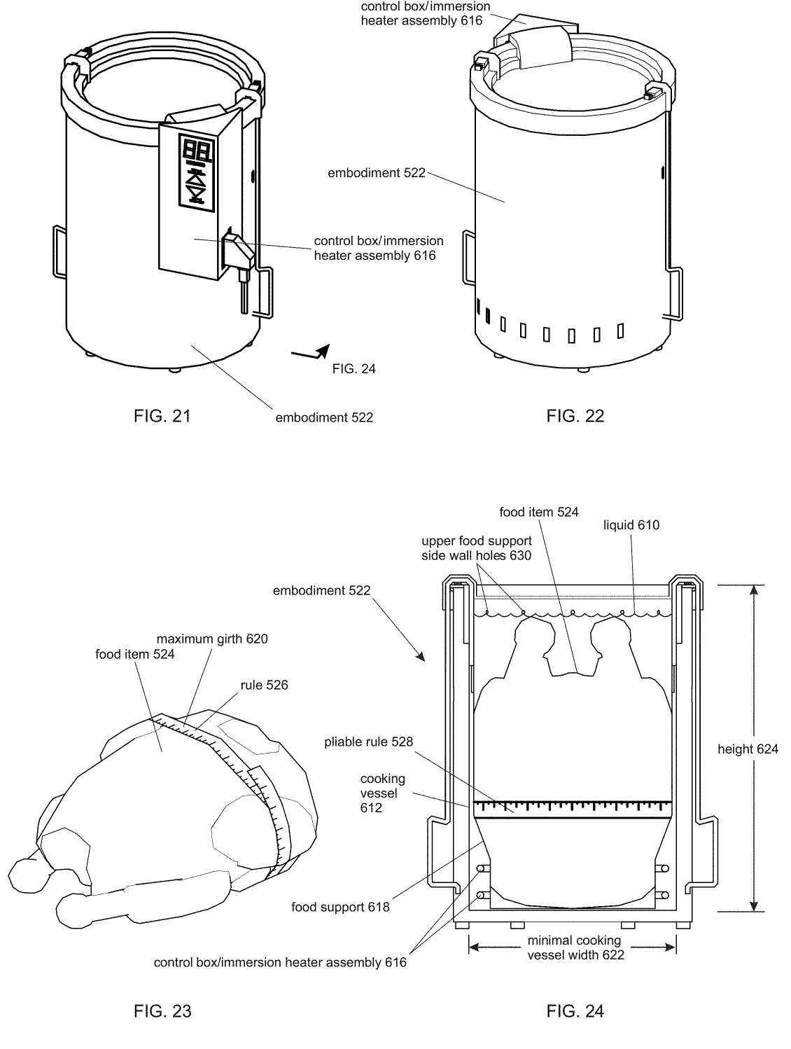

### FIGS. 21 Through 25, Embodiment 522:

Embodiment 522 is a fryer for food items. Embodiment 522 may cook food items by completely submerging them in liquid 610 contained within cooking vessel 612; or by partially submerging food items, and cooking the food items in multiple stages, only a portion at a time.

Embodiment 522 is comprised of outer enclosure 614 which encircles and removably mounts, along and above upper edge 615 of outer and closure 614. Outer enclosure 614 also removably mounts, on control box mount 617, control box/immersion heater assembly 616 which is configured to heat liquid 610 and food items 524 within cooking vessel 612 to thermostatically controlled cooking temperatures. Thermal sensor tube 619 houses thermal sensors for both thermostatic control and thermal overload protection.

Food support 618 may dispose food item 524 within cooking vessel 612. Food support 618 may position food items in any desirable disposition, including, but not limited to, vertically with feet up (FIG. 24) or feet down (not shown); horizontally; diagonally; etc. (also not shown). Food support 618 may be made of any suitable material including, but not limited to, formed metal or plastic, or other suitable material; and may advantageously exhibit a nonstick interior surface, at least to resist food sticking, to aid in easy food removal, and to facilitate cleanup.

Food support 618 may compress the girth (circumference) of food items, and particularly of large food items, by 5%, or more. As a non-limiting and non-exhaustive example, and referring to FIGS. 23 and 24, food item 524 might have a maximum girth 620 (circumference) of 25 inches when measured by rule 526 (FIG. 23) while resting on a horizontal support surface. However, when food item 624 is placed within food support 618, its maximum girth (circumference) may be reduced to 23.75 inches (95% of 25 inches=23.75 inches) or less, as measured by pliable rule 528 (FIG. 24), due to the compressive forces exerted by food support 618.

To accommodate elongated foods, such as, by way of a non-limiting and non-exhaustive example, a foul; cooking vessel 612 may advantageously have a vertical cross-section (FIG. 24) aspect ratio of a height which is 1.3 times or more times its minimal width. So as an example, using FIG. 24, if minimal cooking vessel width 622 were 9.5 inches, height 624 would be 12.35 inches (1.3×9.5 inches equals 12.35 inches) or greater.

Food support 618 may be made from non-pierced wall material such as formed metal, or plastic, or other suitable material. Advantageously, food items placed within food support 618 may have 50% or more of their outer surfaces in direct face-to-face contact with the not-pierced inner surfaces of food support 618. This amount of direct face-to-face contact may help contain moisture, flavors, and other desirable elements within foods being cooked within food support 618. This in turn may at least make the cooked foods more flavorful and moist. It also may promote food tenderness, by at least slow cooking and steam cooking such foods internally in a manner analogous to a slow cooker.

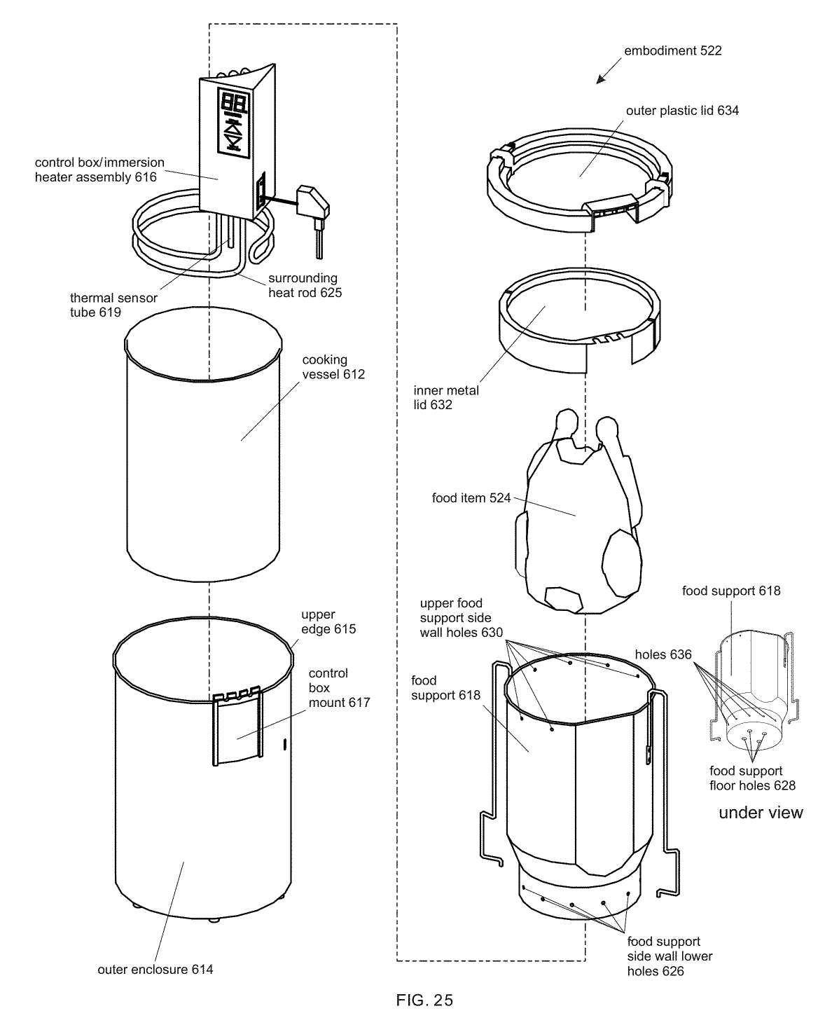

FIG. 25 shows an exploded perspective view of embodiment 522.

Control box/immersion heater assembly 616 includes surrounding heat rod 625, which may wrap around the outer perimeter of the bottom of foods inserted into cooking vessel 612, allowing foods to rest directly on the floor of cooking vessel 612 (see in particular FIG. 24).

This in turn may allow a lower overall height for embodiment 522. Advantageously, the overall height of embodiment 522 should not exceed 16 inches, as this dimension is generally recognized as the standard for minimal clearance between kitchen countertop upper surfaces, and the bottom over countertop cabinetry. Embodiment 522 is advantageously configured to be at least stored below over kitchen countertop cabinetry.

Food support side wall lower holes 626 and food support floor holes 628 help safely regulate how fast fluids can flow into and flow out of food support 618. The size and placement of food support side wall lower holes 626, and food support floor holes 628 help control how fast cooking liquid flows into food support 618, when food support 618, containing food to be cooked, is lowered into cooking liquid contained in cooking vessel 612.

In general, embodiment 522 advantageously has holes 636 and 628 in the lower half of food support 618, which help control ingress and egress of fluids, in and out of food support 618. This in turn may help to safely control the rate of boiling activity when foods are first introduced into hot liquids contained in cooking vessel 612, by regulating the rate of flow of hot cooking liquid that can enter food support 618; and it might help safely control hot cooking liquid splatter that boiling activity within food support 618 might generate, by regulating the rate hot cooking liquids and gases can exit food support 618.

Food support floor holes 628 are also advantageous in providing full drainage of food support 618.

Upper food support side wall holes 630 may provide the same benefits of safely controlling boiling rates and oil splatter, through basically the same manner of controlling ingress and egress of fluids from food support 618.

Inner metal lid 632 corks the top of food support 518. Inner metal lid 632, in combination with outer plastic lid 634, help safely cap outer enclosure 614, cooking vessel 612, and food support 618. Cooking liquid which overflows cooking vessel 612 is held in the bottom of the space between outer enclosure 614 and cooking vessel 612, until cooking liquid can be safely recycled or disposed of. This safety feature may help to protect kitchen countertops from accidental hot cooking liquid overflow.

As a non-exhaustive and non-limiting example, in use, the user defrosts, cleans, and fully dries the food to be cooked such as food item 524, portrayed as a Thanksgiving day sized turkey.

The user then fills cooking vessel 612 with enough cooking liquid 610, such as cooking oil, to fully immerse food item 524. The user then sets control box/immersion heater assembly 616 to heat the cooking liquid 610 to cooking temperatures.

The user then may put food item 624 into cooking vessel 612. If food item 524 is a turkey, it may be placed into cooking vessel 612, either feet up or feet down.

Once the cooking liquid is up to cooking temperatures, the user then slowly drops food support 618 and contained food item 524, into hot cooking liquid 610 contained within cooking vessel 612, and leaves it there until cooking is complete.

When cooking is complete and, food support 618 and contained food item 524 are withdrawn from cooking vessel 612, and food item 524 may be removed from food support 618 for serving.

In tests, in most cases, including cases where a food item 524 was so large that its girth (circumference) was reduced by 5% or more when it was placed within food support 618, the uniformly golden brown food item (turkey) just slides out of the nonstick inner surface of food support 618.

If any cooking liquid has overflowed at any time during the cooking, the user then simply empties it from outer enclosure 614 for recycling or disposal.

Embodiment 522 may at least offers a user: a compact countertop footprint; a simple, very quick, one cooking step (if so configured) food preparation method; and an unbelievably good tasting food item, such as turkey which is uniformly golden brown, unusually tender, extremely juicy, and naturally very delicious.

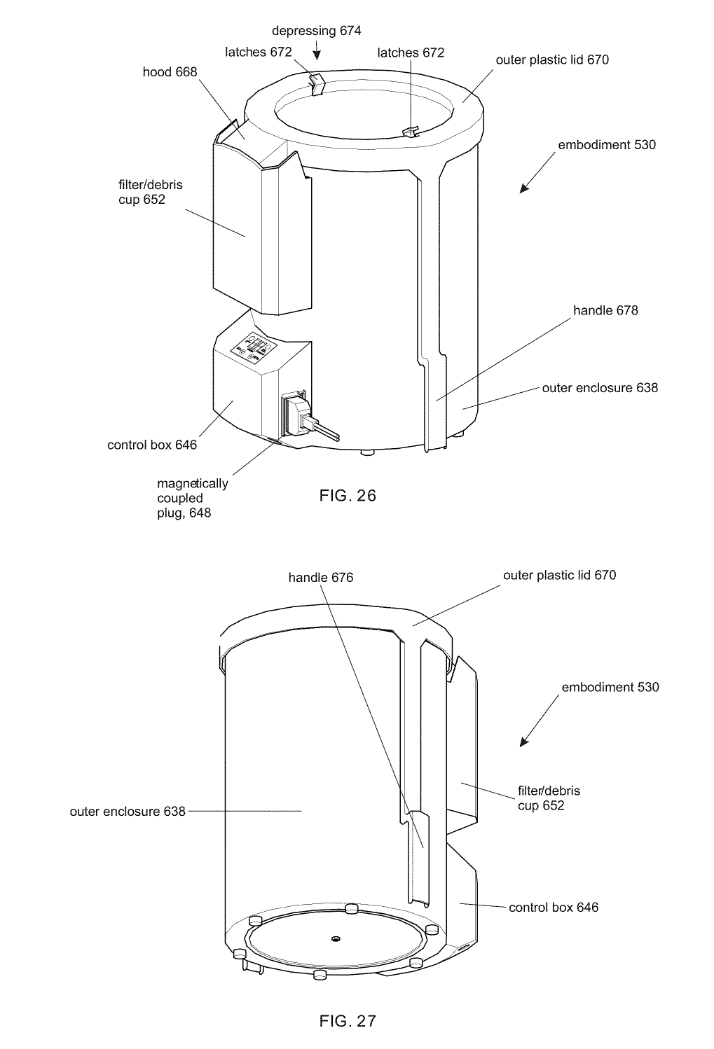

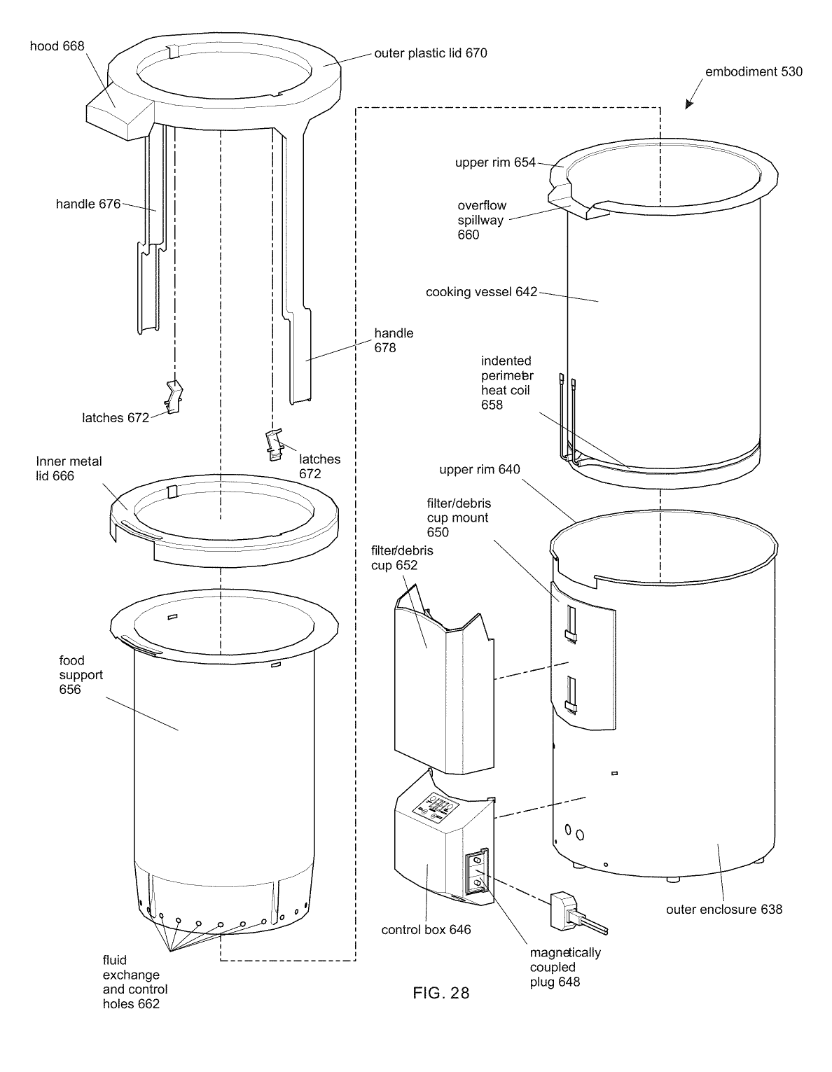

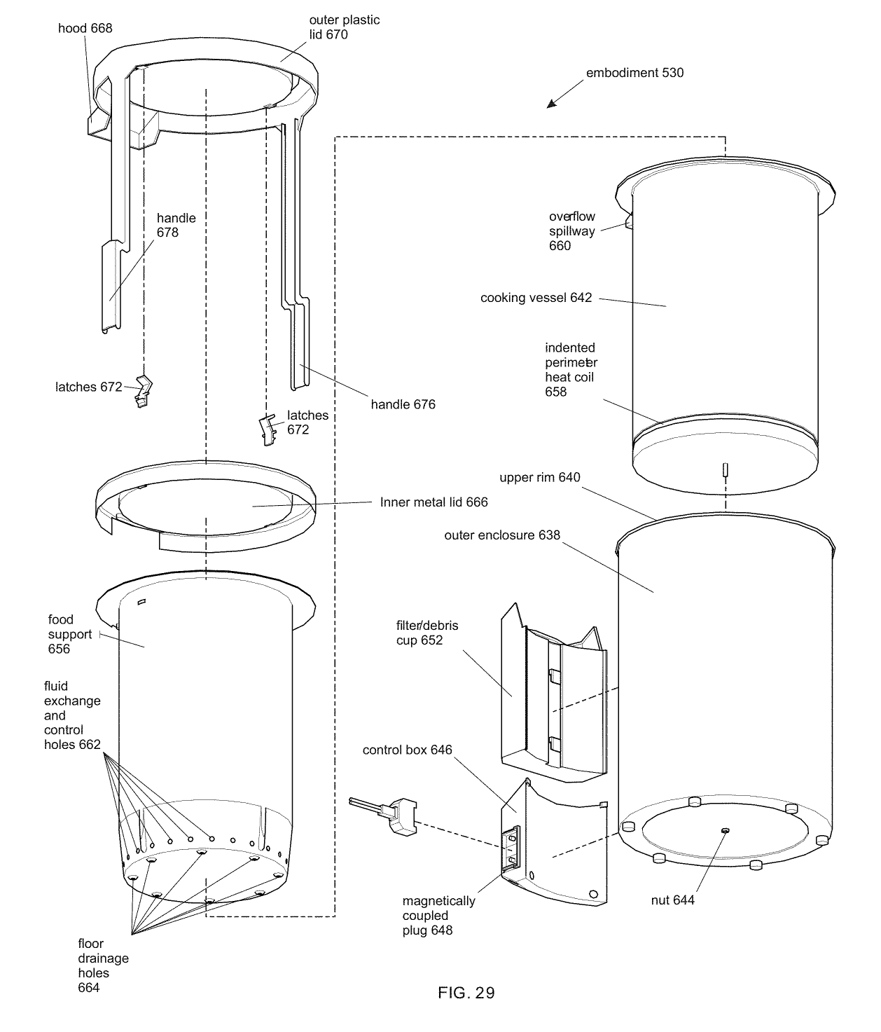

### FIGS. 26 Through 29, Embodiment 530:

Embodiment 530 comprises outer enclosure 638, which fixedly mounts, on and above upper rim 640, cooking vessel 642, using nut 644.

Outer enclosure 638, on the lower portion of its forward face, fixedly mounts control box 646. Control box 646 contains controls to regulate the time and temperature of cooking. It also mounts magnetically coupled wall power plug 648.

Also on the forward face of outer enclosure 638, filter/debris cup mount 650, disposed above control box 646, mounts filter/debris cup 652.

Cooking vessel 642 is configured, along upper rim 654, to rest and mount food support 656. Cooking vessel 642 also mounts proximate to its floor, and indented into its side wall, indented perimeter heat coil 658, which provides heat to bring cooking liquid and food within food support 656 to cooking temperature.

Overflow spillway 660 is indented downward into upper rim 654 of cooking vessel 642, and facilitates the passage of gases and excessive liquid from the cavity formed between food support 656 and cooking vessel 642, toward filter/debris cup 652.

Food support 656 includes fluid exchange and control holes 662, and floor drainage holes 664, both of which help safely control the rate of hot cooking liquid flow into food support 656, as well as the violence of gases and liquids exiting from food support 656. Floor drainage holes 664 also help to completely drain food support 656 of cooking liquids.

Inner metal lid 666 is configured to cork food support 656.

Controlling fluid exchange, be it gaseous or liquid, between food support 656 and cooking vessel 642 is done by fluid exchange and control holes 662 and floor drainage holes 664.

Gases and/or liquids exiting cooking vessel 642 are generally directed through overflow spillway 660, where they are deflected by hood 668 on outer plastic lid 670 downward into filter/debris cup 652.

In general, exhaust entering into filter/debris cup 652 is subdivided. Liquids fall to the bottom of filter/debris cup 652. Gases, odors and vapors are filtered through at least condensation onto surfaces within filter/debris cup 652. Some may remain on such surfaces as residue, and some may condense into liquid which is also collected in the bottom of filter/debris cup 652. Some of the exhausts entering into filter/debris cup 652 may also be filtered by passing through filter media itself within filter/debris cup 652.

Filter/debris cup 652 is advantageously constructed from translucent or transparent material. Should overflow occur for any reason, including, but not limited to, lowering food into cooking vessel 642 too rapidly or putting too much liquid into cooking vessel 642, overflowing cooking liquid may obviously be seen flowing into filter/debris cup 652 by the user, prompting corrective user action.

Filter/debris cup 652 is advantageously constructed from materials which are dishwasher safe, at least to facilitate cleanup. At the end of a cook session, filter/debris cup 652 may be easily removed, its liquid contents dumped and/or recycled, and filter/debris cup 652 placed in a dishwasher for easy cleaning.

Inner metal lid 666 is fixedly attached to outer plastic lid 670. Latches 672 removably attach outer plastic lid 670/inner metal lid 666 assembly to the upper portion of food support 656.

Depressing 674 (FIG. 26) latches 672 simultaneously releases engagement between the assembled lids and food support 656, and allows their separation. Placing outer plastic lid 670/inner metal lid 666 assembly onto food support 656, engages latches 672 and couples outer plastic lid 670/inner metal lids 666 assembly to food support 656.

When so coupled, handles 676 and 678 on outer plastic lid 670 may be used to lift and maneuver food support 656, and its contents.

As a non-limiting and non-exhaustive example of how embodiment 530 might be used to cook a turkey:

The user would do the normal cooking preparation for a turkey of defrosting, washing, and thoroughly drying.

The user would then lower the turkey into food support 656, either breast up or breast down, and latch outer plastic lid 670/inner metal lid 666 assembly onto food support 656, by dropping the lid assembly onto food support 656, and allowing latches 672 to engage. Latches 672 are spring-loaded to engage by leaf springs which are not shown.

The user would fill cooking vessel 642 with sufficient cooking liquid to fully immerse the food article to be cooked. Using control box 646, the user would then heat this liquid to cooking temperature.

After the cooking liquid reaches cooking temperature, using handles 676 and 678, the user would then lower food support 656 and its food contents into the cooking temperature oil contained within a cooking vessel 642, and allow it to be so disposed long enough for cooking to occur.

At any time during this cooking period, the lid assembly may be removed and replaced using latches 672. This may help intermediate inspection of the food being cooked.

After cooking is complete, using handles 676 and 678, the user would then remove food support 656 from cooking vessel 642. The user would then uncouple the lid assembly from food support 656 and remove its cooked food contents for serving.

If any oil had accidentally overflowed during cooking, the user would dump filter/debris cup 652 for reuse or disposal.

The user, after each cooking session, would generally either rinse and/or dishwasher clean filter/debris cup 652.

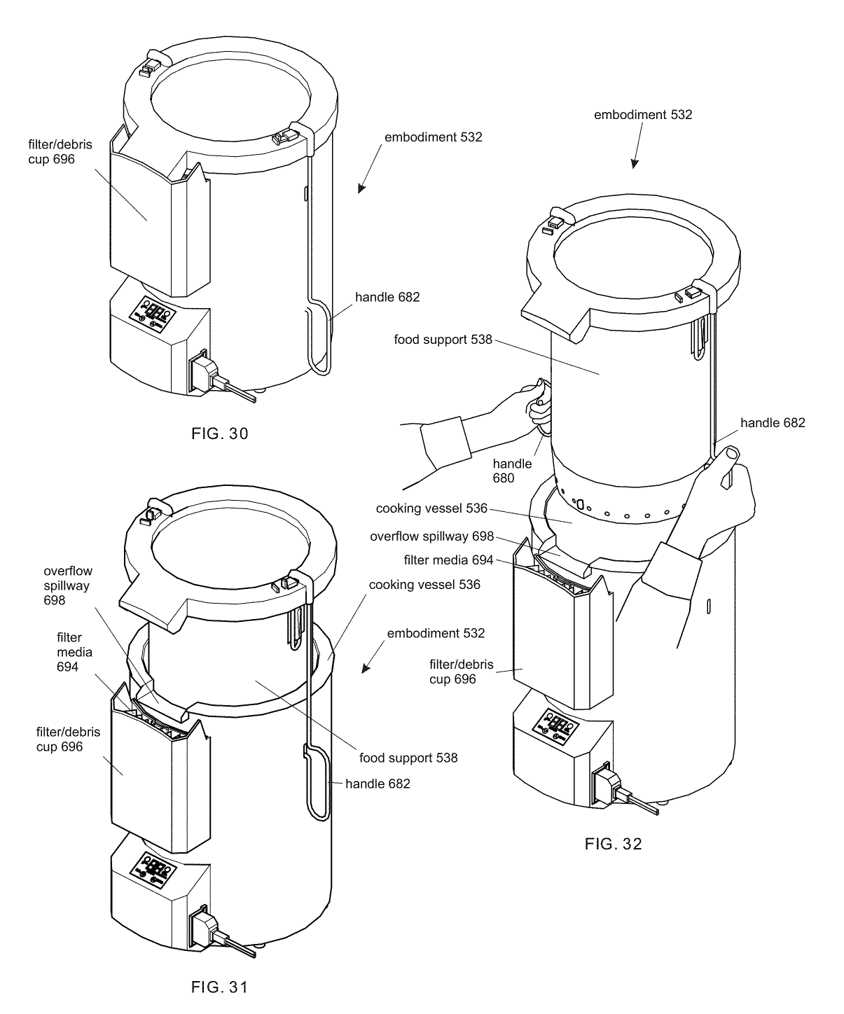

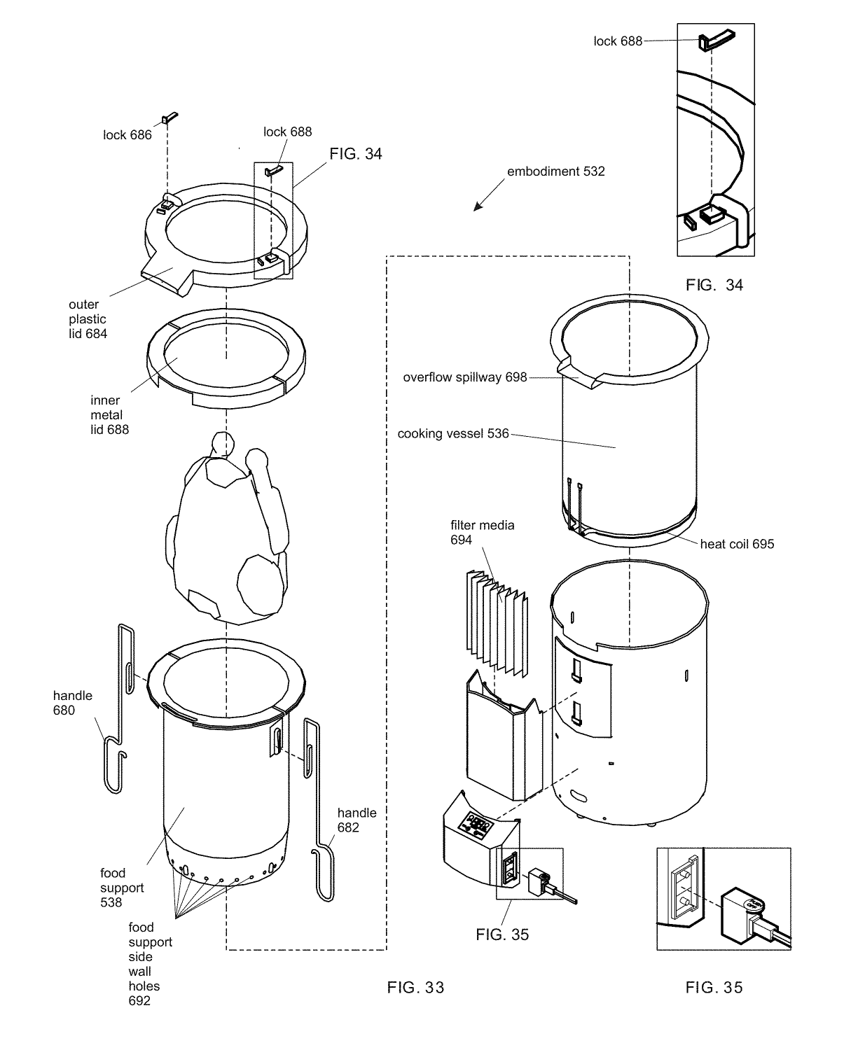

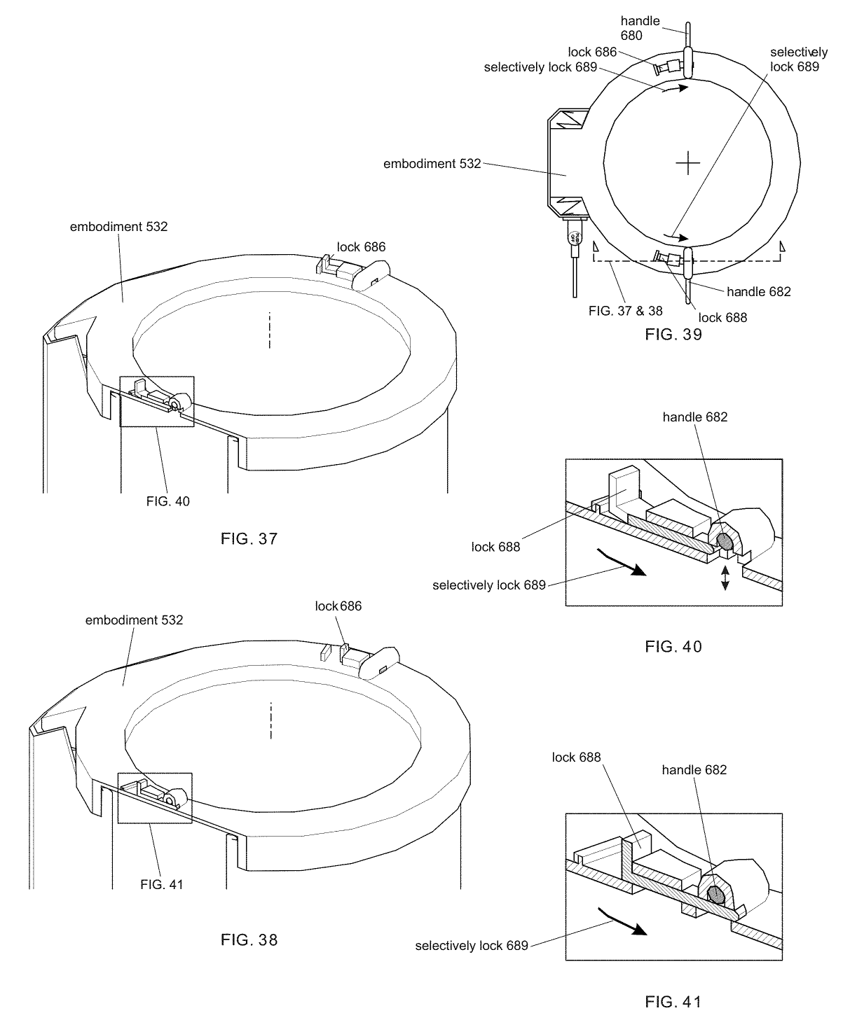

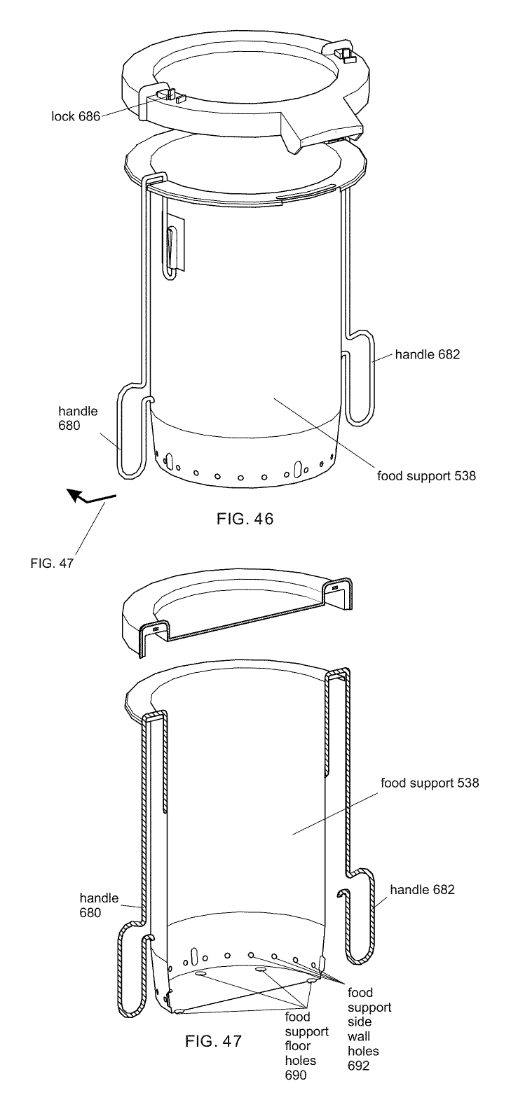

### FIGS. 30 Through 47, Embodiment 532:

FIGS. 30 through 47 show embodiment 532 which in many respects is constructed like, and functions similarly to embodiment 530.

However, in embodiment 532, handles 676 and 678, which were integral with outer plastic lid 670 of embodiment 530, are replaced with handle 680 and handle 682 which are directly removably attached to food support 538.

Also, outer plastic lid 684 in embodiment 532 replaces outer plastic lid 670 of embodiment 530. Outer plastic lid 684 has lock 686 and lock 688, which, as shown in FIGS. 37 through 41, selectively lock 689 under handles 680 and 682 respectively, to fixedly secure outer plastic lid 684, with attached inner metal lid 688, onto the top of food support 538.

Inner metal lid 688 in turn in essence corks the top of food support 538, which has the effect of containing, within food support 538, the sometimes violent reaction that occurs, as a non-limiting and non-exhaustive example, when a moist turkey is introduced into hot frying oil.

When food support 538 containing food is lowered into hot oil in cooking vessel 536, hot oil enters into food support 538 only at the rate allowed by food support floor holes 690 and food support side wall holes 692, thus helping control the rate of turkey/hot oil interaction.

Oil, steam, debris, etc. may exit food support 538 at a rate allowed by food support floor holes 690 and food support side wall holes 692, thus helping to control the amount of turbulence and activity in the space formed between the inside of cooking vessel 536 and the exterior of food support 538.

Embodiment 532 includes filter media 694, which is removably disposed within filter/debris cup 696. Filter media 694 is portrayed as being an accordion folded sheet. As a non-limiting and non-exhaustive example, such a sheet could be made of: filter paper, paper, paper towels, metal (such as stainless steel; aluminum; chromium, nickel, or nonstick coated mild steel; etc.), perforated or expanded metal, plastic, fiberglass mat or fabric, nonwoven polyester, or any other suitable material, or any other suitable perforated or nonperforated form.

Filter media 694 might also have other forms, such as a monolithic block, or extruded or other suitable form shapes. As non-limiting and non-exhaustive examples, it might be a block of reticulated foam, or be a plurality of metal ball bearings, or be plastic or silicon marbles, or be rolled up cloth, or a felt block, or any other suitable form having surface to accept condensed or deposited debris.

Filter media 694 also might be disposable or reusable.

All such embodiments would at least perform the function of providing surface area on which exhausted debris leaving overflow spillway 698 might deposit and/or condense. This may greatly reduce undesirable orders and pollutants leaving embodiment 532.

And any and/or all such embodiments, as a non-limiting and non-exhaustive example, might advantageously allow for limited or unlimited reusability, and be configured to be cleaned, such as in a sink, or a clothes washer, or a dish washer, etc.

As a more detailed non-exhaustive and non-limiting example, an accordion folded perforated stainless steel sheet might be used for filter media 694, and be periodically washed in a dishwasher.

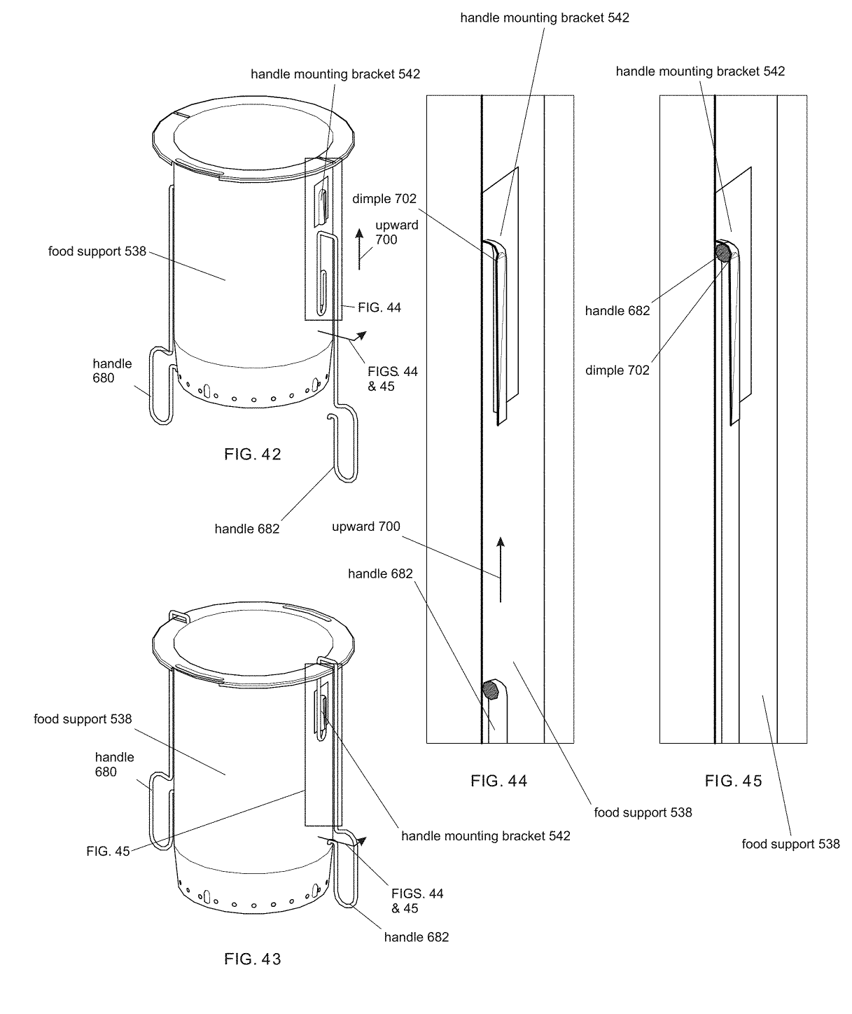

Referring especially to FIGS. 42 through 45, handle 682 is removably attached to food support 538 by sliding it upward 700 into handle mounting bracket 542, using both friction and snap dimple 702 to secure it in place within the downward opening handle mounting bracket 542. Dimple 702 is configured to allow handle 682 to be snapped out of handle mounting bracket 542, simply by pushing hard down on the top of handle 682.

This handle engagement arrangement is rotated to the opposite side of food support 538 for handle 680. This rotation versus a reflection for the opposite handle engagement means that handles 680 and 682 have identical outward forms and are interchangeable, thus potentially lowering user confusion (i.e., picking up the wrong handle).

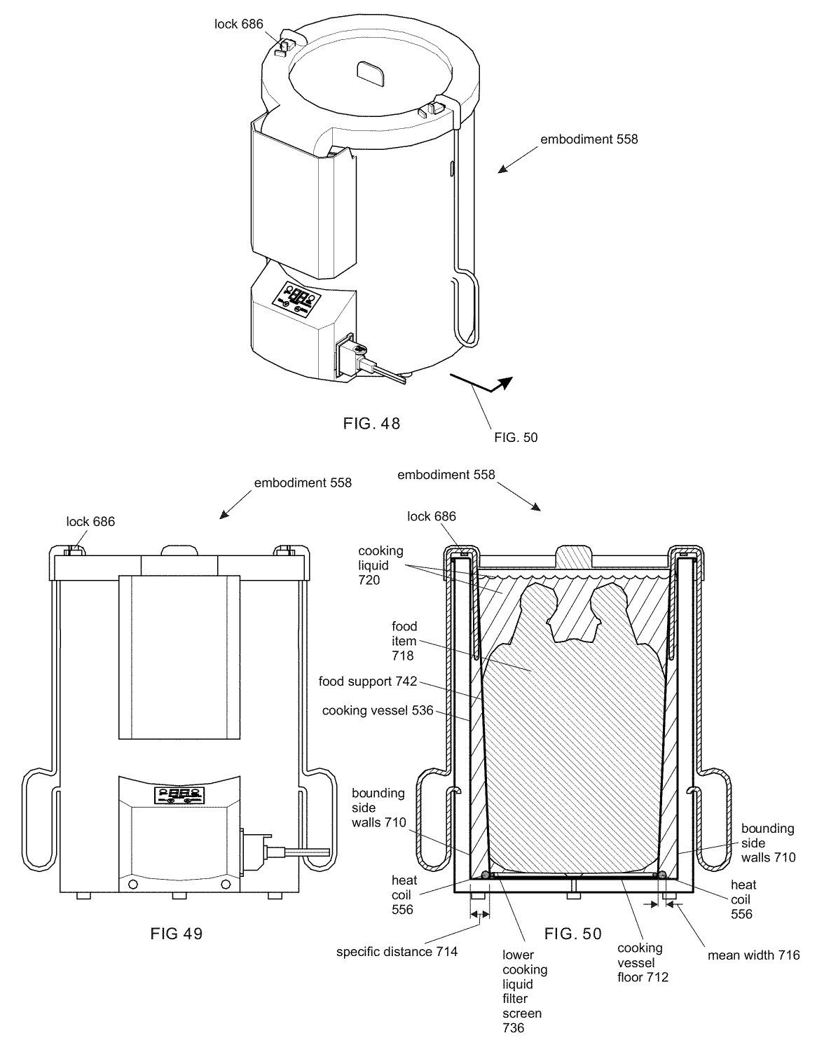

### FIGS. 48 Through 56, Embodiment 558:

Embodiment 558 shares many obvious construction and functional details with embodiment 532.

However, in FIGS. 50, 54, and 56, embodiment 558 shows heat coil 556 which is embedded into floor 706 of cooking vessel 708. This is different than heat coil 695 in embodiment 532, which is disposed indented into the side wall of cooking vessel 536 proximate to its floor.

As shown best in FIG. 50, heat coil 556 is indented upward into cooking vessel floor 712, and is spaced inward specific distance 714 from the intersecting projection of bounding side walls 710. No individual portion of heat coil 556 is horizontally further from the shortest distance to the downward intersecting projection of bounding side walls 710 than 4 times mean width 716 of heat coil 556.

As an example, if mean width 716 of heat coil 556 is 0.30 inches, no individual portion of heat coil 556 is further than 1.20 inches (4×0.30 inches=1.20 inches) from the shortest distance to the intersecting projection of bounding side wall 710.

Put another way, specific distance 714, which is the shortest distance between the inside of coil 556 and the inside of bounding side walls 710, can be no larger than four times mean width 716, which is the mean width of heat coil 556.

Disposing heat coil 556 close to side walls 710, allows room in the central portion of cooking vessel floor 712 for portions of foods, such as food item 718, to directly touch cooking vessel floor 712, without being raised up by heat coil 556. This in turn may help reduce the overall height of embodiment 558, which advantageously, as explained earlier, should be less than the 16 inch standard distance from countertops, over countertop cabinetry.

As another way of looking at this, having food item 718 have direct contact with cooking vessel floor 712, may increase the achievable height of any given food item 718 within any specific height embodiment 558

FIG. 50 also shows how embodiment 558 might fully immerse food item 718 in cooking liquid 720, and thereby be configured to cook food item 718 in a single step.

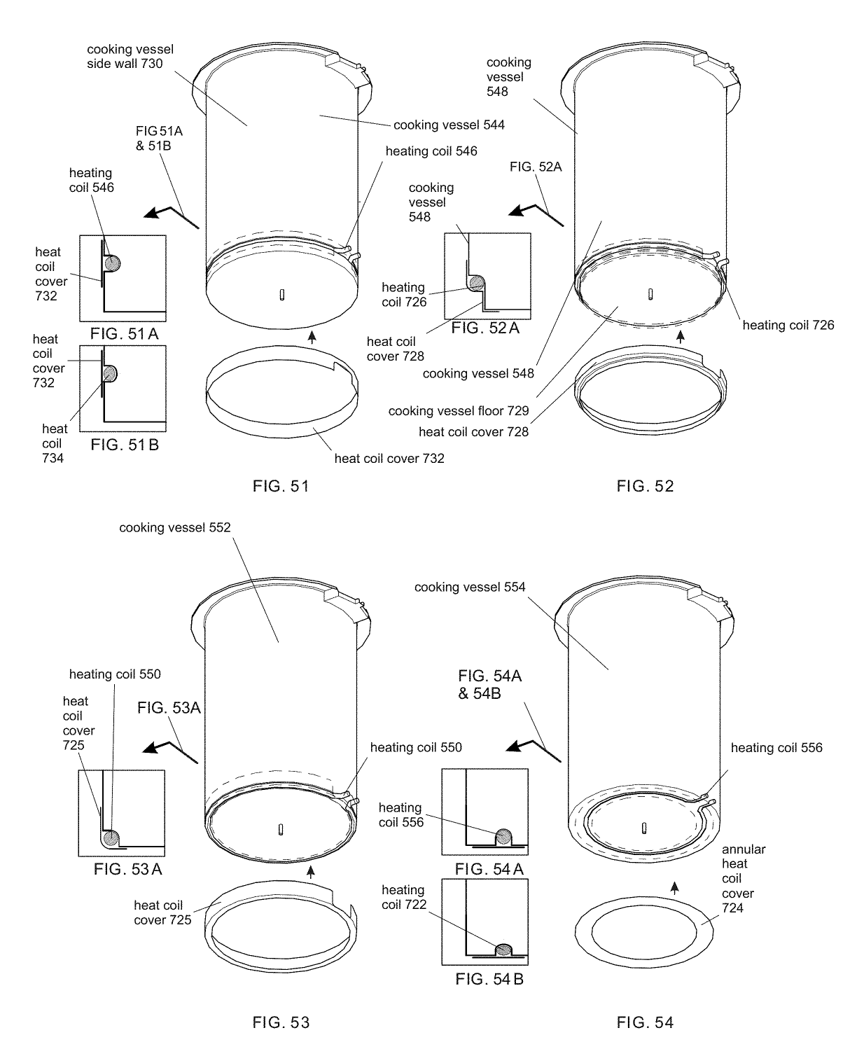

FIGS. 51 through 54 show different configurations for mounting heat coils within embodiment 558.

FIG. 54A shows heating coil 556 as it is portrayed in FIG. 50.

FIG. 54B is identical to FIG. 54 A, except it shows heating coil 722 which is a flattened version of heating coil 556. This flattening may reduce heat coil 722's upward intrusion into cooking vessel 536, and therefore increase usable cooking space within cooking vessel 536.

Annular heat coil cover 724 may optionally cover heat coil 556. Annular heat coil cover 724, as a non-limiting and non-exhaustive example, might be constructed of any suitable material, including at least chrome or nickel coated steel, brushed or shiny stainless steel, or any other suitable material. The shininess or reflectiveness of heat coil cover 724 may help increase the heat transfer efficiency, by reflecting radiant heat which might otherwise be lost from heat coils 556 or 722.

FIGS. 53 and 53A show heating coil 550 which is indented into the lower perimeter edge of cooking vessel 552. Heat coil cover 725 may optionally be mounted over heating coil 550, as shown in detail in FIG. 53A, and may be constructed to increase heat transfer efficiency, as explained for annular heat coil cover 724 above.

FIGS. 52 and 52A are identical to FIGS. 53 and 53A except heating coil 726 is raised above cooking vessel floor 729 and is optionally covered by heat coil cover 728, which may be constructed similarly to, and perform functions like, annular heat coil cover 724.

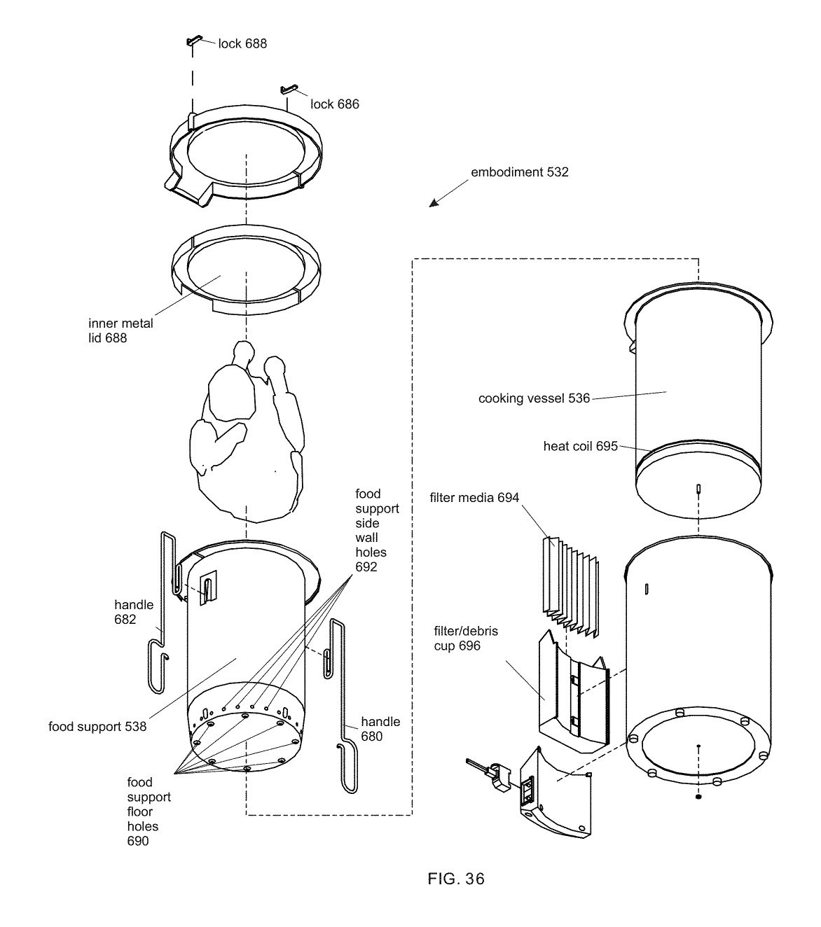

FIG. 51 shows heating coil 546 in a disposition similar to that shown earlier in FIGS. 33, and 36 for heat coil 695; that is partially up, and indented into, cooking vessel side wall 730.

As shown in FIGS. 51 and 51A, heat coil cover 732, may be constructed and function similarly to annular heat coil cover 724, and may cover heating coil 546, or its more flatly formed counterpart, heat coil 734.

In each of the embodiments shown in FIGS. 51, 51A, 51B, 52, 52A, 53, 53A, 54, 54A, and 54B, a thermal dispersion medium, such as, for non-limiting and non-exhaustive examples, thermal paste or aluminum powder, disposed between each heat coil and surrounding cooking vessel walls and heat coil cover walls, may advantageously aid thermal transfer efficiency.

Regarding FIGS. 51 through 54, which heat coil is best suited to any given situation is dependent upon many factors, including, but not limited to: ease of fabrication, degree of space utilization efficiency needed, degree of thermal transfer efficiency needed, as well as potentially other factors.

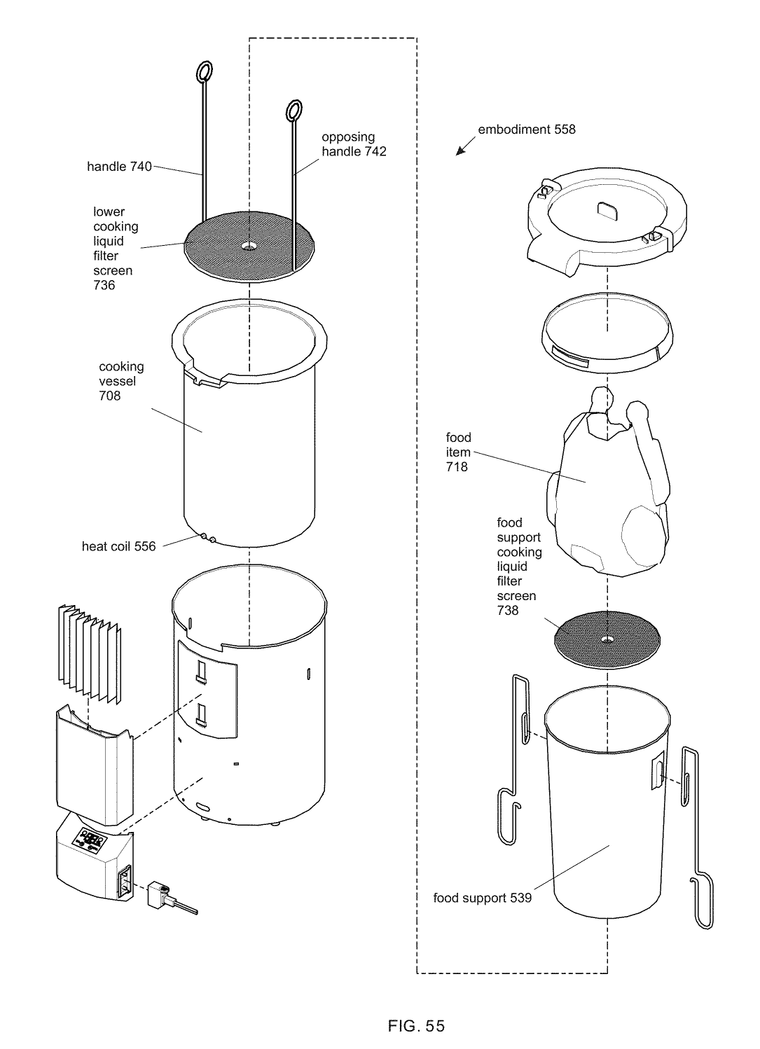

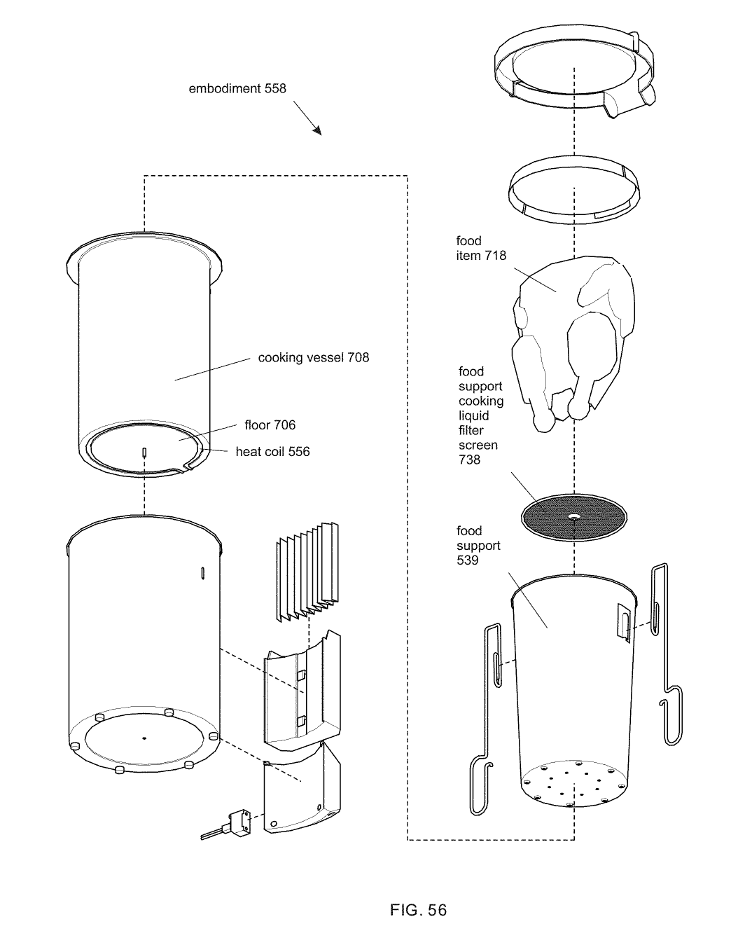

FIGS. 55 and 56, Embodiment 558 with Options:

FIG. 55 is a perspective which shows embodiment 558, with optional lower cooking liquid filter screen 736, and optional food support cooking liquid filter screen 738. Both screens 736 and 738, automatically filter cooking liquid, such as deep frying oil, when each is pulled upward and removed from cooking liquid containing cooking vessel 708.

And either screen or both screens, 736 and 738, may be constructed similar to, and function in a similar manner to filter screen 578 described earlier herein, or they may be constructed in any other suitable manner.

FIG. 56 is a perspective taken from below the ground plane, and shows embodiment 558 with optional food support cooking liquid filter screen 738.

FIG. 55 shows lower cooking liquid filter screen 736, with handle 740 and opposing handle 742, which protrude above the surface of cooking liquid contained within cooking vessel 708 when food support 539 and contained food are removed from cooking vessel 708. Handles 740 and 742 thus allow handle grips to aid in the removal of lower cooking liquid filter screen 736 from liquid within cooking vessel 708, without the user touching cooking liquid contained within cooking vessel 708.

As non-limiting and non-exhaustive examples of how embodiment 558 might be used with lower cooking liquid filter screen 736 and/or food support cooking liquid filter screen 738: Embodiment 558 may also be used without the presence of filter screen and filter screen 738.

When using lower cooking liquid filter screen 736, the user does all the normal cooking set up of pouring a predetermined amount of cooking liquid into cooking vessel 708 and heating the cooking liquid to cooking temperatures.

After adding and preheating cooking liquid into cooking vessel 708, the user places cooking liquid filter screen 738 and food item 718 above it, into the bottom of cooking vessel 708, and lowers food support 539 into cooking vessel 708. Cooking liquid then flows into food support 539 through food support cooking liquid filter screen 538, thus filtering the cooking liquid.

Once preheated cooking oil and lower cooking liquid filter screen 736 are in cooking vessel 708, food support 539 containing food item 718 is lowered into cooking vessel 708, and cooking is conducted for a predetermined amount of cooking time.

At the end of this cooking time, food support 539 containing food item 718 is removed from cooking vessel 548 and food item 718 is served.

At any time after food support 539 is removed from cooking vessel 548, two alternative courses of action can occur.

The first is, cooking liquid is poured out of cooking vessel 736, and afterword, lower cooking liquid filter screen 736 is removed from cooking vessel 548 for dishwasher, sink, or other suitable cleaning. In such case, lower cooking liquid filter screen 736 may be reusable after cleaning.

Or, lower cooking liquid filter screen 738 may be disposable or contain disposable elements, such as paper, paper towels, or paper drip coffee filter material, or other suitable disposable material. In such cases, the user would simply dispose of the disposable element of lower cooking liquid filter screen 736.

The second alternative course of action is, lower cooking liquid filter screen 736 is lifted and removed from cooking liquid contained within cooking vessel 708. The cooking liquid within cooking vessel 708 is then either saved or disposed of; and lower cooking liquid filter screen 736 is cleaned in a dishwasher, or sink, or in another suitable way. After such cleaning, lower cooking liquid filter screen 736 may be ready for reuse as described above.

Food support cooking liquid filter screen 738 is used passively to filter cooking liquid whenever food support 539, containing food support cooking liquid filter screen 738, is either lowered into or removed from cooking liquid contained within cooking vessel 708.

As non-exhaustive and non-limiting example of how food support cooking liquid filter screen 738 might be used.

A user would pour a predetermined amount of cooking liquid into cooking vessel 708 and heat it to a predetermined cooking temperature.

Next, the user would lower food support 539 containing food support cooking liquid filter screen 738 near and above its floor; and containing food item 718 within it; into the preheated cooking liquid contained in cooking vessel 708; and the user would then leave food item 718 in the hot cooking liquid for a predetermined cooking time; at the end of which time, the user would then remove food support 539, containing food item 718 and food support cooking liquid filter screen 736; from the hot cooking liquid contained in cooking vessel 708.

Food item 718 would then be served, and food support cooking liquid filter screen 738 would be removed from food support 539 and cleaned in a sink, dishwasher, or other suitable manner. After such cleaning food support cooking liquid filter screen 738 would be ready for reuse, as described above.

Or again, if food support cooking liquid filter screen 738 is comprised of disposable material, such disposable material may simply be thrown out.

Both lower cooking liquid filter screen 736 and food support cooking liquid filter screen 738 are optional. They both may be absent, or used independently, or used in combination. Using either food support cooking liquid filter screen 738 or lower cooking liquid filter screen 736 may reduce cleanup, and may prolong the useful life of cooking liquid, such as frying oil which can be very expensive.

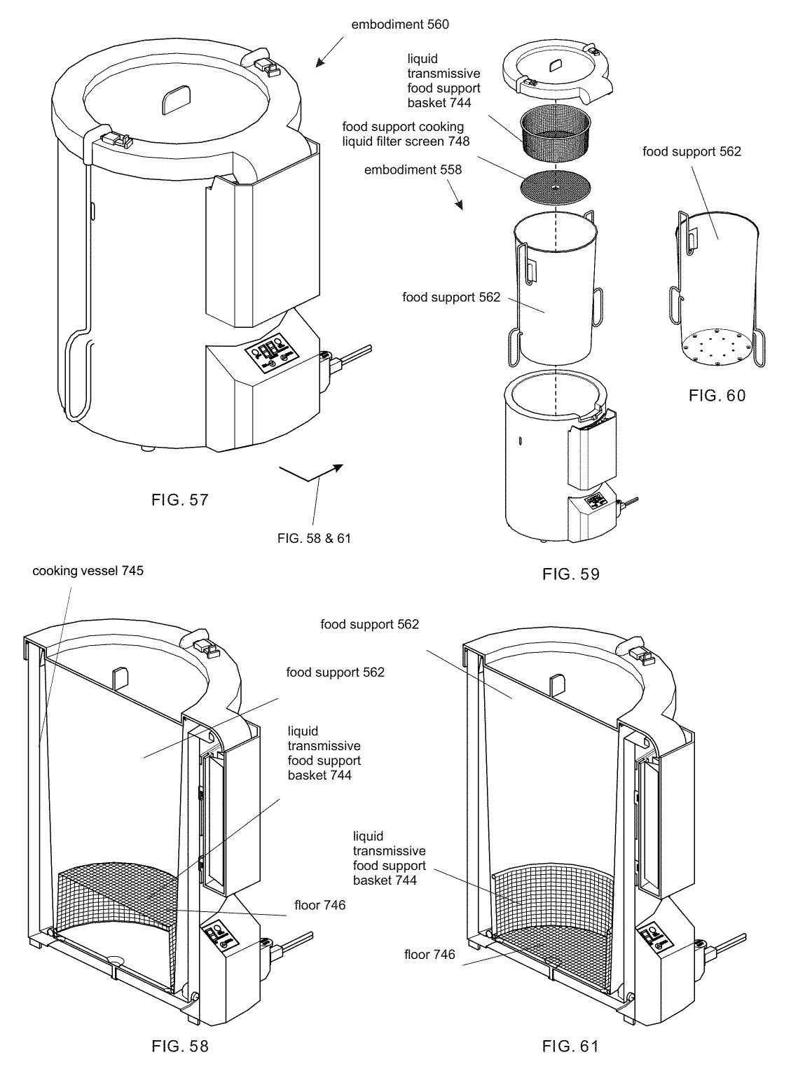

### FIGS. 57 Through 61, Embodiment 560:

FIGS. 57 through 61 show embodiment 560. Embodiment 560 uses liquid transmissive food support basket 744 to hold and support both unitary and pleural food items. As shown in FIGS. 58 and 61, liquid transmissive food support basket 744 may be used opening upwards. In such disposition, food items are placed in the upward opening basket 744 for cooking. This, as a non-limiting and non-exhaustive example, may be used for frying or boiling foods in hot liquids contained within cooking vessel 745.

In FIG. 58, liquid transmissive food support basket 744 is shown in use positioned opening downward. In such disposition, food items are placed within food support 562 and rested on inverted floor 746 of food support 562. This, as a non-limiting and non-exhaustive example, might be used for steaming food items, where the steam food item is rested on floor 746 of liquid transmissive food support basket 744 (FIG. 58) and the elevation that inverted floor 746 provides, may raise the food being steamed above the boiling steaming liquid.

FIG. 59 also shows the use of food support cooking liquid filter screen 748, which may be similar in use, construction, and function to food support cooking liquid filter screen 738.

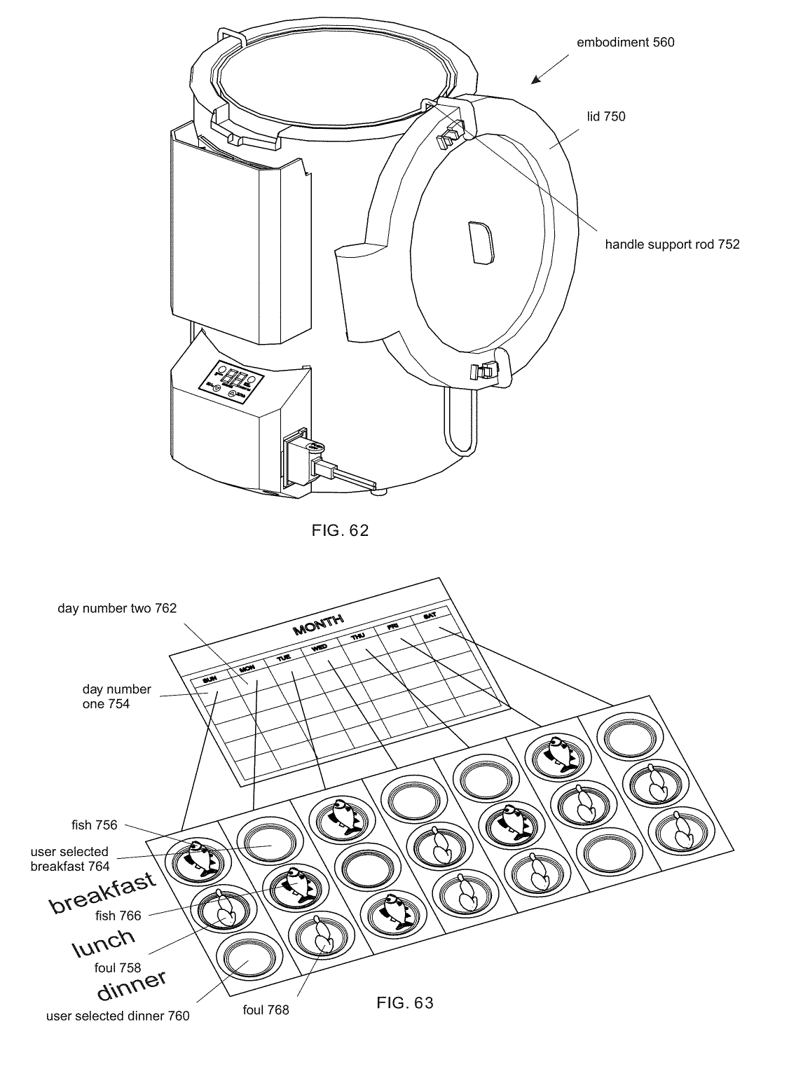

### FIG. 62, Embodiment 560:

FIG. 62 shows embodiment 560 which configures lid 750 to be removably and friction snap-fit coupled to handle support rod 752 during use, storage, or at other times.

### FIG. 63, a New Use for Fried Food:

Fried foods have long been synonymous with gaining weight. However, when used properly, eating deep fried foods without generally associated carbohydrates, such as breading and potatoes, can actually result in substantial weight loss.

As one non-limiting and non-exhaustive example, deep fried fish, and deep fried foul may be consumed for a one week or longer period, during each day's two of the major three mealtimes of breakfast, lunch, and dinner. It is important that during such mealtimes, only deep fried fish and/or deep fried foul is consumed, particularly making sure that no other breading, sugar, or carbohydrates are consumed during the same meal.

FIG. 63 gives a graphic representation of how this might occur. Day number one 754, shows deep fried fish 756 for breakfast, deep fried foul 758 for lunch, and a user selected dinner 760.

Day number two 762 shows a user selected breakfast 764, with deep fried fish 766 for lunch, and deep fried foul 768 for dinner.

To lose substantial weight, for seven contiguous days or longer, an individual must eat only deep fried fish and/or deep fried foul for at least two of the three major meals every day, without combining the deep fried foods with other foods during the same meal, and particularly without combining the deep fried foods with carbohydrates during the same meal. In FIG. 63, this is typically illustrated for day number one 754 and day number two 762.

Also showing promising weight loss results, is regime similar to the above, but substituting red meat, such as beef, lamb, pork, etc., for all or some of the fish and fowl described. As a non-exhaustive and non-limiting example, referring to FIG. 63, a user might have ham for breakfast instead of fish 756, and a hamburger for lunch, instead of foul 758.

Or as another non-limiting and non-exhaustive example, for each day in the weight loss period represented in FIG. 63, wherever fish is shown as a meal, a beefsteak, or lamb chop, might be substituted; and for each day in the weight loss period, wherever foul is shown as the meal, ham or a hamburger might be substituted.

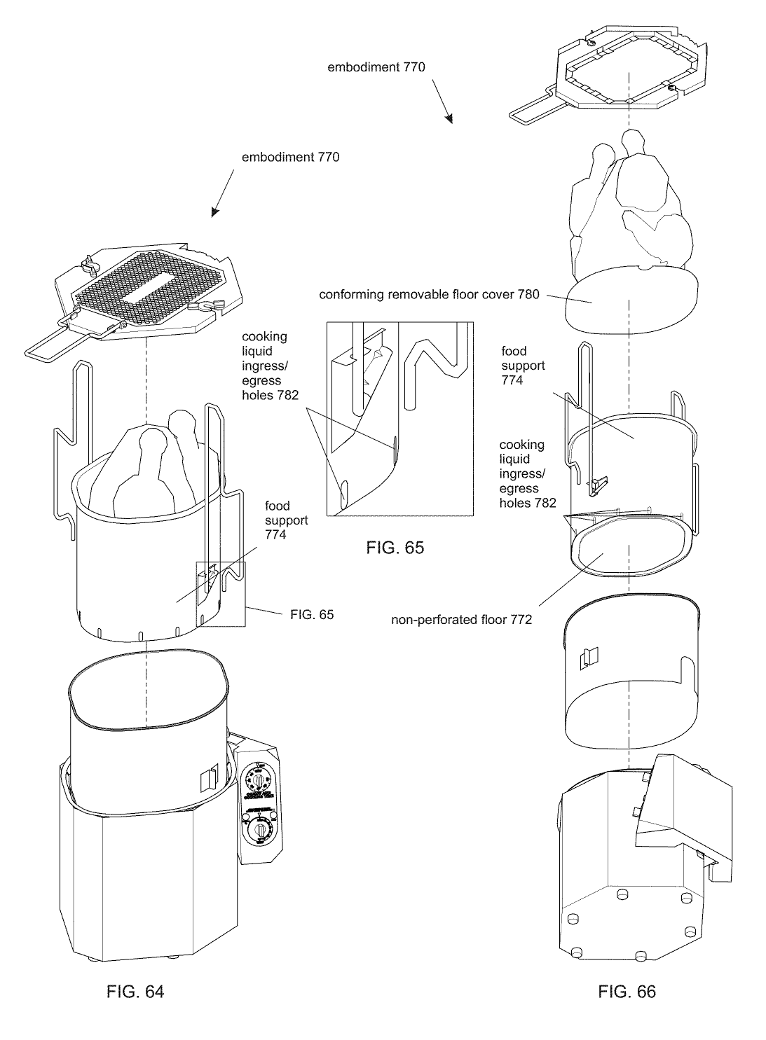

### FIGS. 64, 65, and 66, Embodiment 770:

FIG. 64 through 66 show embodiment 770 which is a variant of embodiment 516, and shares many of its construction and function specifications with embodiment 516. However, instead of having filtering floor 604 capping the bottom of embodiment 516, embodiment 770 has non-perforated floor 772 capping the bottom of food support 774. And unlike embodiment 516, which removes debris from cooking liquid by passing cooking liquid through filtering floor 604, at least when food support 776 is lowered into, or removed from cooking vessel 778; embodiment 770 filters cooking liquid by allowing debris to settle by gravity onto non-perforated floor 772. Non-perforated floor 772 may be constructed with conforming removable floor cover 780 covering non-perforated floor 772's upper surface. Such a construction would allow removal of conforming removable floor cover 780 for cleaning or other purposes.

Conforming removable floor cover 780, may be constructed of any suitable material, including, as non-limiting and non-exhaustive examples: metal, plastic, paper, elastomer, composite, pliable material, rigid material, or other suitable material; and may have many forms including, but not limited to: non-perforated or perforated sheet form, bed of nails, back-to-back bed of nails, screening of any coarseness, corrugate, dimpled, textured, ridged, or any other suitable form.

Embodiment 770 drains food support 774 of cooking oil or other materials through cooking liquid ingress/egress holes 782 which are located on the generally vertical side wall of food support 774 and on the outer periphery of non-perforated floor 772. Because cooking liquid ingress/egress holes 782 are generally vertical, settling debris tends not to exit through them.

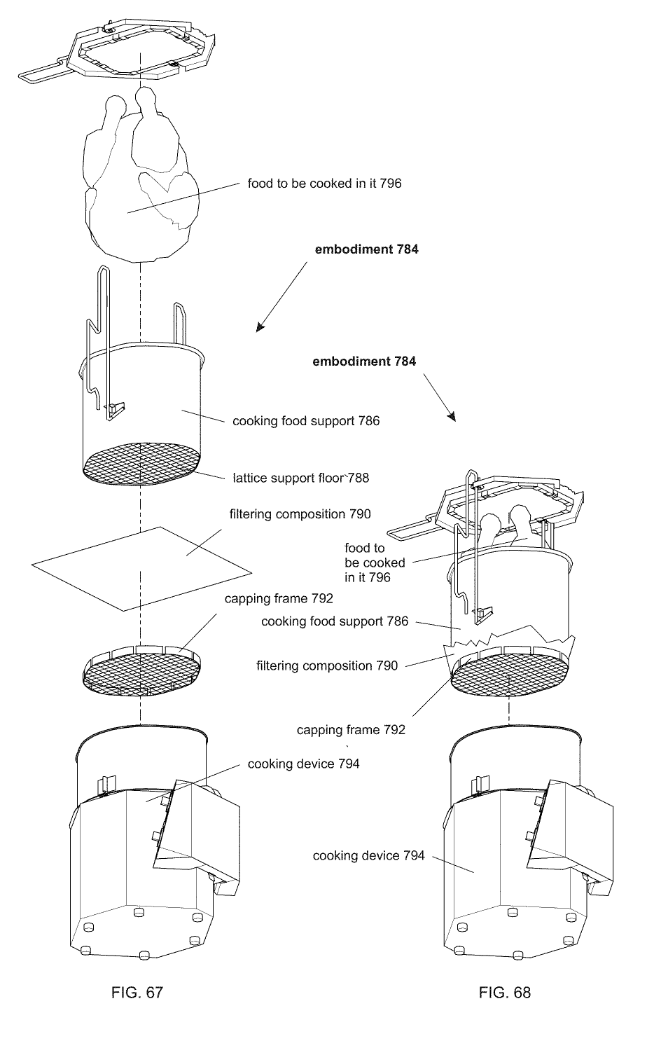

### FIGS. 67 and 68, Embodiment 784:

FIGS. 67 and 68 show embodiment 784 which comprises cooking food support 786 which has lattice support floor 788 spanning support 786's base, and lattice support floor 788 providing structural support for food items being cooked.

Filtering composition 790 is disposed below lattice support floor 788, and may be flexible as shown, or may be rigid and trimmed to fit within capping frame 792, which snaps onto the bottom of food support 786 and covers and supports filtering composition 790. As a non-limiting and non-exhaustive example, filtering composition 790 may be constructed in a similar manner to filtering screen 578.

Lattice support floor 788 may advantageously exhibit a nonstick outer surface. This may help in preventing food to be cooked 796 from sticking to filtering composition 790.

As a non-limiting and non-exhaustive example, embodiment 784 may be used as follows.

First, the user would prepare the cooking device 794, and food to be cooked in it 796 in the usual specified manner generally comprising placing cooking liquid into cooking device 794's cooking vessel, heating the cooking liquid to cooking temperatures, and cleaning and preparing food 796 according to recipe.

Next, the user places filtering composition 790 across the bottom of cooking support 786 and snaps filtering composition 790 into place by pushing capping frame 792 onto the bottom of cooking food support 786.

Next, food 796 is placed into cooking food support 786 and lowered into cooking device 794, and is then left there until cooking is complete, at which time the user lifts cooking food support 796 out of cooking device 794 and serves food 796.

Cleanup may be done as described for filter screen 578. Filtering composition 790 may be configured to be washable and reusable, or may be disposable, such as, as a non-limiting and non-exhaustive example, a such as filtering composition 790 being a paper towel.

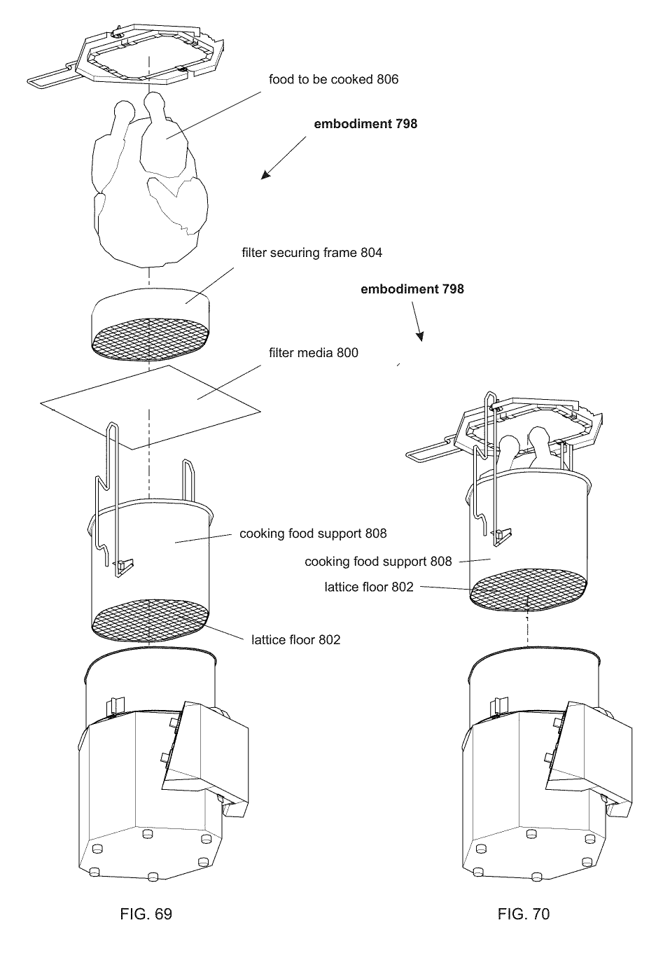

### FIGS. 69 and 70, Embodiment 798:

Embodiment 798 shares many construction and function details with embodiment 784. However, instead of placing filtering composition 790 below lattice support floor 788 and holding it in place with capping frame 792, as in embodiment 784, embodiment 798 reverses the order and places filter media 800 above lattice floor 802 and holds it in place with filter securing frame 804, which disposes filter media 800 between the outer vertical side wall of filter securing frame 804 and the interior of the vertical side wall of cooking food support 808. Filter securing frame 804 advantageously may have a liquid transmissive floor, which, like the rest of the filter securing frame 804, may advantageously exhibit a nonstick surface. This helps to at least ensure that food to be cooked 806 does not stick to filter media 800, as well as it helps to facilitate cleanup.

What has been shown herein are several specific embodiments as well as and combinations thereof, all of which shall be considered as part of the teachings herein.

It is claimed:

1. A device to position foods while cooking in cooking liquid, comprising:
a vessel configured to hold cooking liquid and food being cooked in the cooking liquid;
a heat source configured to heat to cooking temperatures, cooking liquid and food being cooked in the cooking liquid, while they are both disposed in the vessel;
a floor configured to support foods being cooked in the vessel;
an un-perforated, annular, generally vertical, side wall, proximate to the floor along the lower edge of the side wall, and configured to surround and directly contact foods while the foods are being cooked in the vessel; and
the floor and the side wall together configured to be dropped into, and to be lifted out of, cooking liquid contained within the vessel.

2. The device of claim 1, further including the vessel configured to support elongated, unitary food while resting horizontally on a horizontal support surface, having a maximum circumference, and this maximum circumference being measured orthogonal to the food's major axis, and the food, while surrounded by the side wall, being compressed by the side wall such that the food's maximum circumference is reduced by at least 5%.

3. The device of claim 1, further including the side wall having a nonstick interior surface.

4. The device of claim 1, further including a horizontal, generally planner, filtering surface abutting the bottom of the side wall, the filtering surface configured to be dropped into, and to be lifted out of cooking liquid contained within the vessel, and when the filtering surface is being dropped into or being lifted out of cooking liquid contained within the vessel, the filtering surface configured to pass cooking liquid through it and to remove debris from cooking liquid passing through the filtering surface.

5. The device of claim 4, further including the filtering surface fixedly coupled to the bottom of the side wall.

6. The device of claim 5, wherein the floor comprises the filtering surface.

7. The device of claim 1, further including the side wall configured such that, when immersed in cooking liquid contained within the vessel, an upper portion of the side wall is disposed above the surface of the cooking liquid.

8. The device of claim 1, further including a first handle, and the first handle coupled to the floor.

9. The device of claim 8, further including a bounding wall extending upward from the periphery of the floor, and the first handle coupled to the bounding wall and thereby the first handle coupled floor.

10. The device of claim 6, further including a second handle coupled to the floor.

11. The device of claim 1, wherein the annular side wall is configured with an adjustable circumference.

12. The device of claim 1, further comprising the side wall including a filtering surface.

13. A device to reduce undesirable emissions from a hot liquid cooking apparatus, comprising:
a vessel configured to hold cooking liquid and food being cooked in the cooking liquid, the vessel having an upper rim;
a heat source configured to heat to cooking temperatures, cooking liquid and food being cooked in the cooking liquid, while they are both disposed in the vessel;
the vessel capped to form an enclosed chamber;
a chamber exit, and the chamber exit proximate to the upper rim of the vessel, and the chamber exit configured to pass fluids from inside the enclosed chamber to outside the enclosed chamber;
an upward opening debris collection cup, having an upward directed upper opening, and configured to accept through the upper opening, emissions emanating from the chamber exit, and the chamber exit configured to direct fluids into the upper opening, and the debris collection cup having an interior surface configured to retain debris including condensed residue emanating from the chamber exit.

14. The device of claim 13, further including the upward opening debris collection cup is light transmissive.

15. The device of claim 13, further including an outer enclosure surrounding the vessel, and the upward opening debris collection cup configured to be removably coupled to the outer enclosure.

16. The device of claim 13, further including removable condensation surfaces within the upward opening debris collection cup, and the removable condensation surfaces configured to retain debris from emissions emanating from the chamber exit.

17. The device of claim 13, further including removable surfaces within the upward opening debris collection cup, and the removable surfaces configured to filter debris from emissions emanating from the chamber exit.

18. The device of claim 17, wherein the removable surface is configured to be disposable.

19. The device of claim 17, wherein the removable surfaces are configured to be reusable.

20. The device of claim 13, wherein the upward opening debris collection cup is configured such that contained content is visible to the device user.

21. The device of claim 13, further including the chamber exit being configured to direct liquids, including cooking liquid, from the vessel and into the upward opening debris collection cup.

22. The device of claim 21, further comprising the chamber exit configured to pass excessive liquid from within the enclosed chamber to an exterior of the enclosed chamber.

23. A device to cook foods in hot cooking liquid, comprising:
a vessel configured to hold hot cooking liquid and food being cooked in the hot cooking liquid;
a heat source configured to heat to cooking temperatures, cooking liquid and food being cooked in the cooking liquid, while they are both disposed in the vessel;
a food support bowl removably disposed within the vessel, configured to hold foods being cooked in hot cooking liquid contained within the vessel, and the food support bowl capped by a lid to form an enclosed chamber; and
at least one orifice penetrating the enclosed chamber and configured to control fluid egress and ingress out of and into the enclosed chamber.

24. The device of claim 23, further including at least one orifice comprising at least one orifice proximate to the bottom of the food support bowl.

25. The device of claim 23, further including at least one orifice comprising at least one orifice proximate to the top of the food support bowl.

26. The device of claim 23, further including at least one orifice configured to control the rate at which hot cooking liquid may enter into the food support bowl.

27. The device of claim 23, further including at least one orifice configured to control the rate at which fluids may egress from the food support bowl.

28. The device of claim 23, further including the vessel covered by a cover, and the cover being fixedly coupled to the lid.

29. The device of claim 23, further including a filtering partition configured to filter debris from cooking liquid passing through the filtering partition, and the filtering partition disposed intermediate of food being cooked in the food support bowl, and the floor of the vessel.

30. The device of claim 29, further including the filtering partition disposed inside the food support bowl, proximate to the bottom of the food support bowl.

31. The device of claim 30, further including the filtering partition having a filtering surface, and the filtering surface vertically spaced away from adjacent horizontal surfaces by at least 1/10 of an inch.

32. The device of claim 29, further including the filtering partition disposed outside of the food support bowl.

33. The device of claim 32, further including the filtering partition having a filtering surface, and the filtering surface vertically spaced away from adjacent surfaces by at least 1/10 of an inch.

34. A device to cook foods in hot cooking liquid, comprising:
a vessel configured to hold hot cooking liquid and food being cooked in the hot cooking liquid,
a heat source configured to heat to cooking temperatures, cooking liquid and food being cooked in the cooking liquid, while they are both disposed in the vessel,
an annular, nonperforated food support sleeve, removably disposed within the vessel, and the annular, nonperforated food support sleeve configured to surround unitary food items while they are disposed in the vessel, and while doing so, the nonperforated food support sleeve having direct face-to-face contact with at least 50% of the outer surfaces of such foods.

35. The device of claim 34, further including interior surfaces of the nonperforated food support sleeve being nonstick coated.

36. The device of claim 34, further including the annular, nonperforated food support sleeve having a generally vertical sidewall.

37. The device of claim 34, further including the annular, nonperforated food support sleeve capped on one end by a filtering surface.

38. A device to cook foods in hot cooking liquid, comprising:
a vessel configured to hold hot cooking liquid and food being cooked in the hot cooking liquid;
a heat source configured to heat to cooking temperatures, cooking liquid and food being cooked in the cooking liquid, while they are both disposed in the vessel;
a food support bowl removably disposed within the vessel, configured to hold foods being cooked in hot cooking liquid contained within the vessel, and the food support bowl capped by a lid to form an enclosed chamber; and
a first lock configured to be manually operated, and to selectively lock the lid onto the food support bowl.

39. The device of claim 38, further including a second lock configured to be manually operated and to selectively lock the lid onto the food support bowl.

40. A safety apparatus on devices to cook foods in hot cooking liquid, comprising:
a vessel configured to hold hot cooking liquid and food being cooked in the hot cooking liquid;
a heat source configured to heat to cooking temperatures, cooking liquid and food being cooked in the cooking liquid, while they are both disposed in the vessel;
a magnetically coupled power plug disposed adjacent to user device control input; and
a user visible marketing associated with the magnetically coupled power plug, indicating “off” and a user action to turn the device off by severing the magnetic connection between the power plug and the device.

41. Heating apparatus on a device to cook foods in hot cooking liquid, comprising:
a vessel configured to hold hot cooking liquid and food being cooked in the hot cooking liquid, and the vessel having a floor and a generally vertical sidewall;
a heat source configured to heat to cooking temperatures, cooking liquid and food being cooked in the cooking liquid, while they are both disposed in the vessel; and
the heat source comprising a rod type electric resistance heating element disposed at the surface of the generally vertical sidewall, and disposed to circumnavigate the vessel.

42. The apparatus of claim 41, further including the rod type electric resistance heater element disposed above the upper surface of the floor.

43. Heating apparatus on a device to cook foods in hot cooking liquid, comprising:
a vessel configured to hold hot cooking liquid and food being cooked in the hot cooking liquid;
the vessel having a floor with a periphery, and the floor having a generally vertical peripheral sidewall, a heat source configured to heat to cooking temperatures, cooking liquid and food being cooked in the cooking liquid, while they are both disposed in the vessel;
the heat source comprising a tubular electric resistance heating element; and
the tubular resistance heating element coupled on the floor, away from the periphery of the floor at a distance not to exceed four times the typical diameter of the tubular electric resistance heating element.

44. A device to cook foods in hot cooking liquid, or to cook foods using vaporized liquids, comprising:
a vessel configured to hold hot liquid and food being cooked;
a heat source configured to heat to cooking temperatures, and to heat to liquid vaporization temperatures, liquids while disposed in the vessel;
a food support configured to be manually lowered into, and to be manually lifted out of the vessel; and
a liquid transmissive food support basket, configured in a first disposition to open upward while resting on the support, and while so disposed, to hold foods being cooked in hot cooking liquid contained within the vessel, and the liquid transmissive food support basket, in a second inverted disposition, configured to open downward while resting on the support, and to support foods being cooked on the inverted floor of the basket using hot liquid vapor.

45. A method to use deep-fried fish, and deep-fried foul to lose weight, comprising the steps of:
Preparing for breakfast, in accordance with a user selection during a first day, breakfast comprising deep fried fish or foul without any carbohydrate coating or accompanying carbohydrates;
Preparing, in accordance with a user selection during the first day, lunch comprising deep fried fish or foul without any carbohydrate coating or accompanying carbohydrates when no user selection is made for breakfast;
if no user selected menu was chosen for breakfast or lunch, preparing, in accordance with a user selection, deep fried fish or foul without any carbohydrate coating or accompanying carbohydrate; and
repeating the previous steps for at least 6 consecutive days directly following the first day.

46. A device to cook foods in hot cooking liquid, comprising:
a vessel configured to hold hot cooking liquid and food being cooked in the hot cooking liquid,
a heat source configured to heat to cooking temperatures, cooking liquid and food being cooked in the cooking liquid, while they are both disposed in the vessel,
a food support bowl removably disposed within the vessel, configured to hold foods being cooked in hot cooking liquid contained within the vessel, and the food support bowl having a liquid transmissive floor,
filtering media removably coupled to the bottom of the food support bowl adjacent to the liquid transmissive floor, and the filtering media configured to remove debris from cooking liquid passing into and out of the food support bowl through the liquid transmissive floor.

47. The device of claim 46, further including the filtering media disposed above the liquid transmissive floor.

48. The device of claim 46, further including the filtering media being disposed below the liquid transmissive floor.

49. The device of claim 46, further including the filtering media is configured to be disposable.

50. The device of claim 49, further including the filtering media is comprised of a paper towel.
